(19) United States
(12) Patent Application Publication
(10) Pub. No.: US 2012/0232973 A1
(43) Pub. Date: Sep. 13, 2012

(54) SYSTEM, METHODS AND APPARATUS FOR INCENTIVIZING SOCIAL COMMERCE

(75) Inventors: DAVID ROBB, CHARLOTTE, NC (US); GRANT NEERINGS, CHARLOTTE, NC (US); JAMES LIVELY, FEDERAL WAY, WA (US); MICHAEL DUNN, SPOKANE, WA (US); COURTNEY SHROCK, SPOKANE, WA (US); JOSEPH RODRIGUEZ, SEATTLE, WA (US)

(73) Assignee: DIY MEDIA, INC., SEATTLE, WA (US)

(21) Appl. No.: 13/046,516

(22) Filed: Mar. 11, 2011

(51) Int. Cl. G06Q 30/00

(52) U.S. Cl. 705/14.17

(57) ABSTRACT

A system, apparatus and methods are described for maintaining sharing relationships in incentivized social commerce using an application server, a database server and a multimedia content distribution system. The application server includes a processor and an interface for communicating over a computer network and is operative to communicate to a database server storing tables for maintaining and earning incentives based on completed purchase transactions using one or more distributed web widgets. The multimedia content distribution system is executed on the processor of the application server and is operative to build and distribute web widgets over a computer network. The web widgets are distributed through sharing relationships in online social communities to stimulate social commerce from the sharing and purchasing of web widgets which provide access to multimedia content.

### FIELD

The present disclosure relates generally to the field of electronic commerce, and in particular but not exclusively, relates to a system, methods and apparatus for incentivizing social commerce using web widgets or other portable content distribution devices for the distribution of multimedia content and the consummation of purchase transactions between content purchasers and distributors of the web widgets or portable content distribution devices.

### BACKGROUND

Electronic commerce on the Internet has become commonplace. Many merchants offer goods and services via web sites on the Internet, and an increasing number of consumers purchase goods and services on various Internet websites. In many cases, the electronic commerce transactions involve electronic content and physical goods. For example, many consumers purchase items such as books, compact disks and digital video disks via the Internet. Increasingly, however, consumers are using the Internet to purchase such items and electronic content such as information products, music or to gain access to web sites that provide news or entertainment stories and to establish social networks of individuals whose opinions can influence what content is reviewed and ultimately purchased by consumers.

More recently, the Internet is being used to engage in a wide variety of social networking between and among different individuals and online communities. When used by businesses to promote their goods and services to such individuals and online communities, this form of networking is called “social media marketing” or more succinctly “social commerce.” In many of these online social relationships, users identify and share recommended content for use and consumption by other users with similar interests, hobbies and/or backgrounds. It is this unique ability to share or “virally distribute” content with recommendations and referrals that now enables the Internet to be used as a highly social medium. Furthermore, this “viral” distribution capability can now be used advantageously by content promoters, such as performing artists, visual artists, video and film producers, and content distribution companies, to create creative works that can be circulated to a far greater number of prospects and partners than may have been possible previously with a distribution capability which was limited only to the content creator's current list of customers.

Current methods for achieving viral distribution of content focus on the use of electronic mail and various social media platforms (e.g., Facebook, Twitter, Xing, MySpace, etc.). Such methods, however, merely enable the distribution of content without effectively stimulating commerce associated with a shared recommendation relating to the content. A significant opportunity and need exists for “incentivized social commerce” that will stimulate the sharing and purchasing of multimedia content.

One current approach that is used to distribute applications of limited functionality involves “web widgets.” A web widget is portable software that can be installed and executed within a hypertext-markup-language web page by an end user that does not require additional compilation. The most commonly used web widgets are discrete applications of limited functionality that allow users to turn personal content into dynamic web applications which can be shared on virtually any website. Current web widgets are limited to executing certain discrete applications as on-screen tools. For example, they are currently used to display on-screen clocks, event countdowns, auction-tickers, stock market tickers, daily weather reports and flight arrival information.

Notwithstanding their useful role in these types of applications, current web widgets are not used as self-contained portable content distribution platforms. Furthermore, these limited functionality web widgets are incapable to a significant extent of exploiting resources on remotely located application servers that enable them to be used to facilitate true “social commerce” to incentivize the consumers and users of the web widgets to continue sharing them with others to significantly increase the number of purchasers of the content associated with the web widgets. Yet, there is a significant need for a system and a method that use enhanced web widgets to stimulate active “social commerce” that will enable content owners to more effectively use viral distribution of multimedia content and to exploit social media marketing trends to increase the number of purchase transactions and other forms of electronic commerce with current and prospective customers using the myriad of devices available to consumers in the marketplace.

### BRIEF DESCRIPTION OF THE DRAWINGS

Non-limited and non-exhaustive embodiments are described with reference to the following figures, wherein like reference numerals refer to like parts throughout the various views unless otherwise specified.

FIG. 1A is a block diagram illustrating an operating environment for a multimedia content distribution system.

FIG. 1B is a block diagram illustrating an alternative operating environment for a multimedia content distribution system.

FIG. 2A is a block diagram illustrating the components of a multimedia content distribution system in an embodiment.

FIG. 2B is a block diagram illustrating the components of an application server in a multimedia content distribution system in an embodiment.

FIG. 2C is a block diagram illustrating the components of a network-based server in an embodiment.

FIG. 3 is a block diagram illustrating a widget builder resource component used in a multimedia content distribution system in an embodiment.

FIG. 4 is a block diagram illustrating a content management component used in a multimedia content distribution system in an embodiment.

FIG. 5 is a block diagram illustrating a market management component used in a multimedia content distribution system in an embodiment.

FIG. 6 is a block diagram illustrating an incentive management service used in a multimedia content distribution system in an embodiment.

FIG. 7A is a flow chart illustrating a method for incentivizing social commerce in an embodiment.

FIG. 7B is a flow chart illustrating a method for managing an incentivized purchase transaction using a web widget in an embodiment.

FIG. 7C is a flow chart illustrating a method for managing an incentivized sharing relationship using a web widget in an embodiment.

FIG. 8 is a flow chart illustrating a method for executing a payment event in a system for incentivized social commerce in an embodiment.

FIG. 9A is a block diagram illustrating a widget sharing table used in a system for incentivized social commerce in an embodiment.

FIG. 9B is a block diagram illustrating a widget sales table used in a system for incentivized social commerce in an embodiment.

FIG. 10 is a flow chart illustrating a method of making a web widget for incentivized social commerce in an embodiment.

FIG. 11A is a flow chart illustrating a method of using a web widget for incentivized social commerce in an embodiment.

FIG. 11B is a continuation of the flow chart set forth in FIG. 11A illustrating a method of using a web widget for incentivized social commerce in an embodiment.

FIG. 12 is a flow chart illustrating incentivized transactions using an incentive management service in an embodiment.

FIG. 13 is a flow chart illustrating incentivized transactions using an incentive management service in an embodiment.

FIG. 14 is a flow chart illustrating incentivized transactions using an incentive management service in an embodiment.

FIG. 15 is a block diagram illustrating a web widget enabled for incentivized distribution of a single musical song in an embodiment.

FIG. 16 is a block diagram illustrating a web widget enabled for incentivized distribution of a musical album including a compilation of musical songs in an embodiment.

FIG. 17 is a block diagram illustrating a web widget enabled for incentivized distribution of a musical catalog including a compilation of musical albums in an embodiment.

### DETAILED DESCRIPTION

In the description to follow, various aspects of embodiments web widgets and the computing and communications system which supports their ability to perform electronic commerce transactions will be described, and specific configurations will be set forth. Numerous and specific details are given to provide an understanding of these embodiments. The aspects disclosed herein can be practiced without one or more of the specific details, or with other methods, components, systems, services, etc. In other instances, structures or operations are not shown or described in detail to avoid obscuring relevant inventive aspects.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

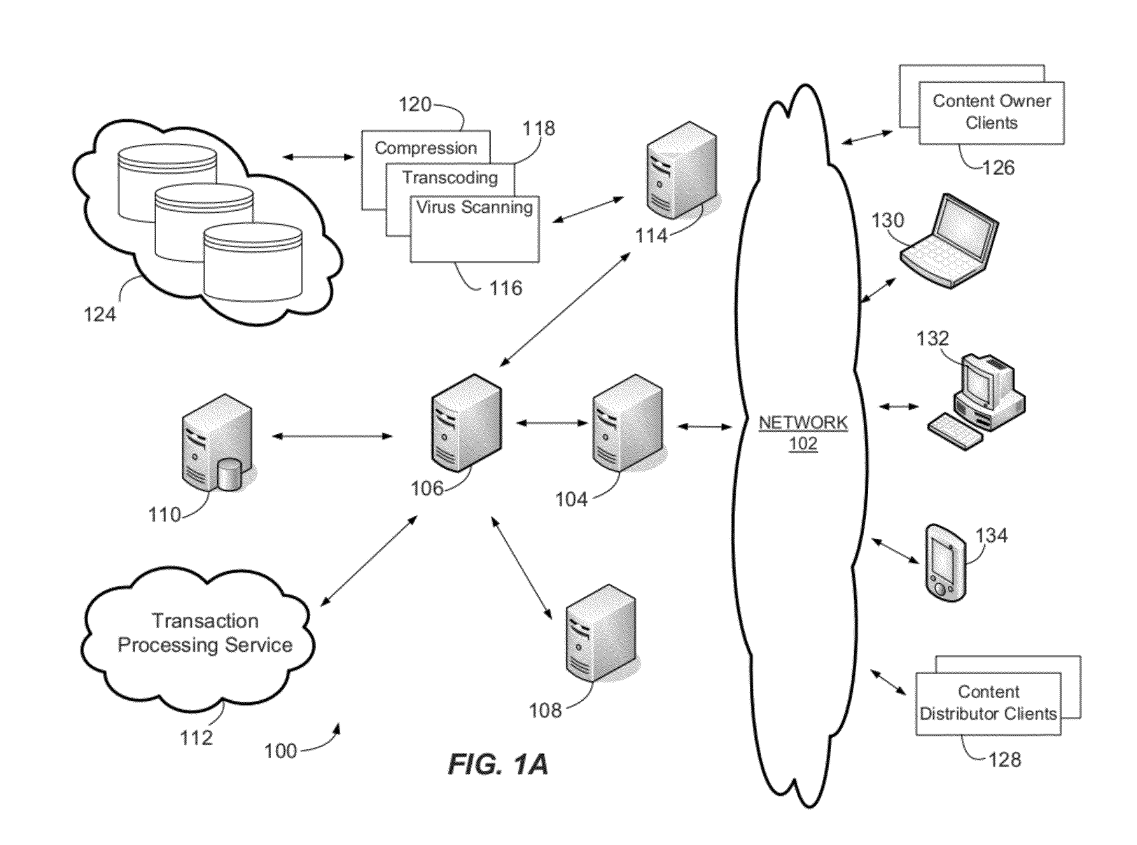

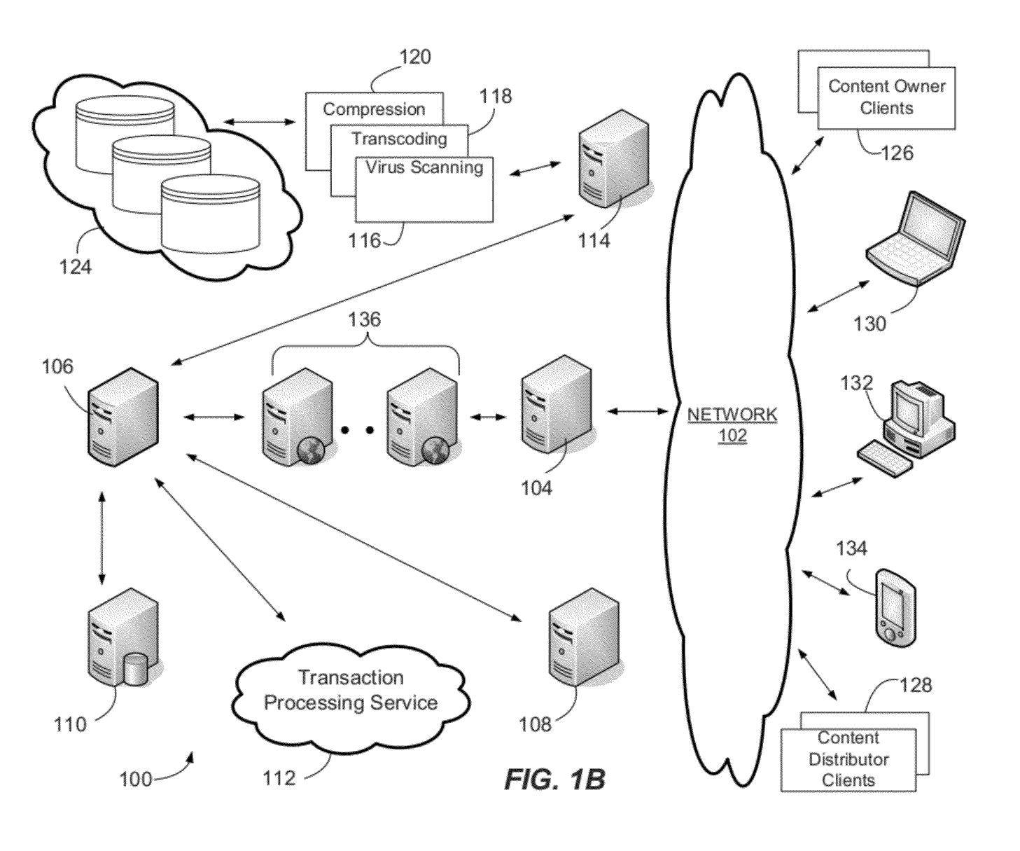

FIG. 1A is an illustration of an operating environment for a multimedia content distribution system in an embodiment. In this operating environment 100, one or more content distributor client devices 128, one or more content owner client devices 126, and one or more consumer client devices 130, 132, 134 are illustrated. Among the range of consumer client devices used for the distribution of multimedia content from the multimedia content distribution system are laptop computers 130, desktop computers 132 and various types of a mobile computing devices 134 such as personal digital assistants (i.e., PDAs). As used here, the term “personal digital assistant” means both phone-enabled PDAs (i.e., smart phones) and non-phone enabled PDAs. Each of these client devices is communicatively coupled to a network 102 which provides secure computing and communications access through a server 104 executing a firewall software to an application server 106, which in this embodiment acts as a centralized compute processing and transaction management resource. In the illustrated embodiment, the network 102 is the Internet, a network of interconnected networks around the world which includes numerous network-based application servers. However, in other embodiments, the network 102 can be a private computer-communications network, a wireless communications network, or other computer data communications network that can enable the execution of applications on various network-based application servers and communications between and among computer devices, mobile devices, the multimedia content distribution system and its infrastructure resources for storage and transaction processing.

The application server 106 is communicatively coupled to a database server 110, a transaction processing service 112, an email server 108 and a file management server 114. The file management server is communicatively coupled to one or more computing resources that perform file virus scanning 116, file transcoding 116 and file compression 120 for files which are stored on a cloud-based storage resource 124. In an embodiment, the database server 110 hosts a database that maintains a lookup table of all content files and related metadata which are stored on the cloud-based storage resource 124. This database also stores a widget sharing table and a widget sales table for the tracking of sharing events and the computation of earned incentives resulting from sales of content from portable content distribution devices (e.g., web widgets) that have been shared by registered members to third party users. The file management server 114 is used to control the file conversion process from a first format in a received file to one or more transcoded formats. In an embodiment, a select subset of the transcoded files will then be compressed into a single file using file compression 120 and then stored on the cloud-based storage resource 124 along with related metadata for each file. In one embodiment, the files are compressed into a WinZip file for storage on the cloud-based storage resource 124. The email server 108 is used in an embodiment to facilitate electronic mail communications between and among content owners and content distributors, as well as email broadcasts to groups of consumers and prospects. In addition to its role in managing the use of resources in the multimedia content distribution system, the application server 106 is also used for the creation of user account profiles, the execution of one or more web servers, and the execution of a content management system including a widget builder resource component and a market management component. The web servers are used to receive and respond to content related requests received from consumer client devices 130, 132, 134.

In one embodiment, content owners using their client devices 126 upload, register in a lookup table stored on the database server 110, manage, package, price and create one or more compilations of stored and registered content for distribution to one or more consumer client devices 130, 132, 134 using compilation-specific web widgets that are created and capable of distribution from the application server 106. In creating web widgets, the application server 106 will check the lookup table stored on the database server 110 to confirm the availability and format of content files included in or associated with the web widgets. This process is also followed when new buttons, links or preview clips are created by content owners for subsequent distribution from the application server 106. The web servers executed on the application server 106 are used to respond to requests received from web widgets, buttons, links or preview clips executed or selected in browsers running on the consumer client devices 130, 132, 134

The content distributor client devices 128 are used by content distributors to provide content distribution feeds to update the content inventories of content owners with active accounts in the multimedia content distribution system on the application server 106. These inventories can be updated with content from distribution feeds upon request of the content owners or the operators of the multimedia content distribution system. In one embodiment, the distribution feeds provide content in bulk which is parsed by a content management system executed on the application server 106 to ensure that each content owner receives the content desired for inclusion in their respective content management systems. Each distribution feed is parsed and the content is allocated to each content owner's account as specified in the distribution feed. Once parsed, the content delivered in these distribution feeds is uploaded, master content files are transcoded to one or more alternative file formats pre-selected by content owners, the content files and their transcoded variants are stored in the cloud-based storage resource 124, and references to the stored content files and transcoded variants are registered in one or more lookup tables maintained on the database server 110. Once uploaded and registered on the database server 110, the content included in these distribution feeds can be accessed and used by content owners to create new content compilations for association with web widgets using a widget builder resource component executed on the application server 106. In an embodiment, a content compilation is an aggregation of one or more multimedia content files and associated metadata. Once created and associated with specific multimedia content and related metadata, these web widgets are available for viral distribution by content owners to networks of current and potential consumers.

In one embodiment, the cloud-based storage resource 124 and the transaction processing service 112 are provided by the Amazon Web Services group at Amazon.com, Inc. More particularly, in the embodiment, the cloud-based storage resource is implemented using Amazon's “Simple Storage Service” (S3) which provides a data storage capacity that can be used to store and retrieve any amount of data, at any time, from anywhere on the World Wide Web. Likewise, in an embodiment, the transaction processing service 112 is implemented using Amazon's “Flexible Payments Service” (FPS) to facilitate the payment processing and checkout process once consumers decide to purchase and download content from virally distributed web widgets, buttons, links or preview clips. In this embodiment, the FPS is used to process payments from consumers who wish to purchase registered multimedia content promoted in virally distributed web widgets, buttons, links or preview clips using their credit cards, debit cards or bank account information. Furthermore, in an alternative embodiment, the file virus scanning 116, file transcoding 118 and file compression 118 processes are implemented using Amazon's “Elastic Compute Cloud” (EC2) resources instead of dedicated, proprietary servers. The EC2 is a web service that provides resizable compute capacity in a cloud-based network that can be scaled to provide computing capacity for applications serving multiple client devices.

Consumers using browsers executing on their client devices 130, 132, 134 can activate web widgets directly or indirectly. A web widget can be activated indirectly if a consumer receives a button or link and then clicks on the button or link which results in the activation of a web widget. Likewise, a consumer can directly activate a web widget if it is received from the content owner or a third party who has opted to share or redistribute the web widget. Once activated, a consumer can opt to preview the content which has been packaged with the web widget, share the web widget with third parties or elect to purchase the multimedia content packaged with the web widget. If a consumer elects to purchase specific multimedia content files by clicking on an embedded buy button, then the web widget provides the consumer with a choice of format options and then redirects the consumer to the transaction processing service 112 for the provision of credit card, debit card or bank account information and completion of the purchase transaction. Once the purchase transaction is completed, the selected multimedia content files are downloaded by the web widget from the cloud-based storage resource 124 to the consumer's designated client device 130, 132, 134.

FIG. 1B is an alternative embodiment of the operating environment of the multimedia content distribution system 100. In this operating environment, one or more web servers have been added as independent computing resources for use in receiving and responding to content related requests from various client devices 130, 132, 134. This embodiment is computationally more efficient and enables the application server 106 to be dedicated to the operation of a content management system and the control of processes on the other servers used in this operating environment. As discussed above, these servers include an email server 108, a database server 110, a file management server 114, and control over a transaction processing service 112 and content conversion services for file virus scanning 116, file transcoding 118, and file compression 120 for storage in the cloud-based storage resource 124.

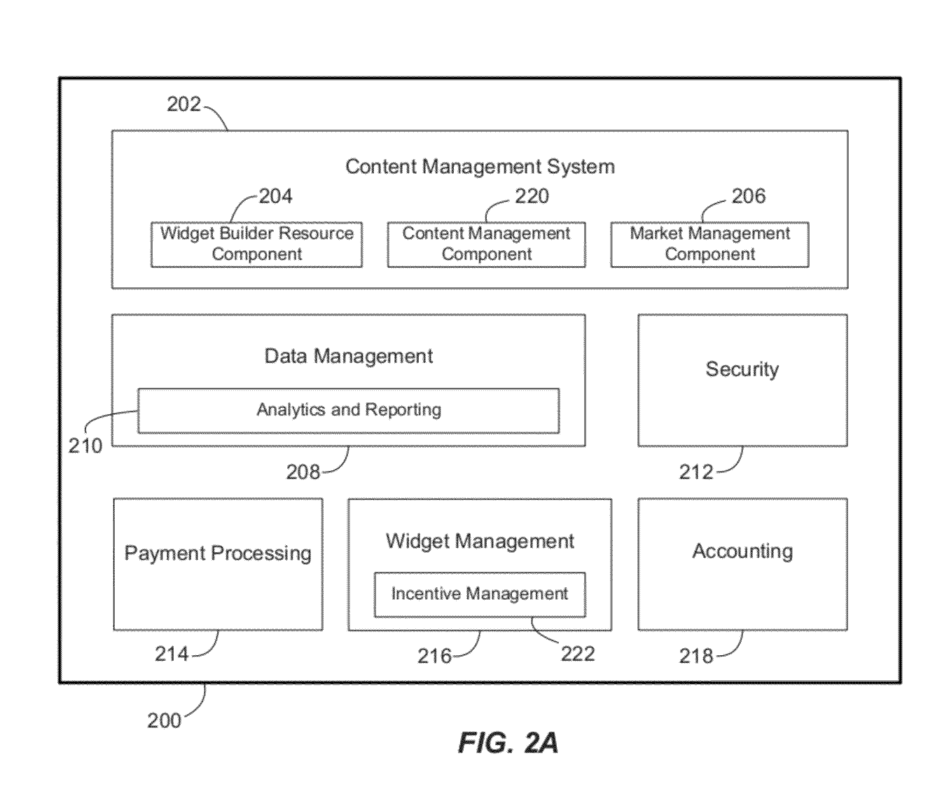

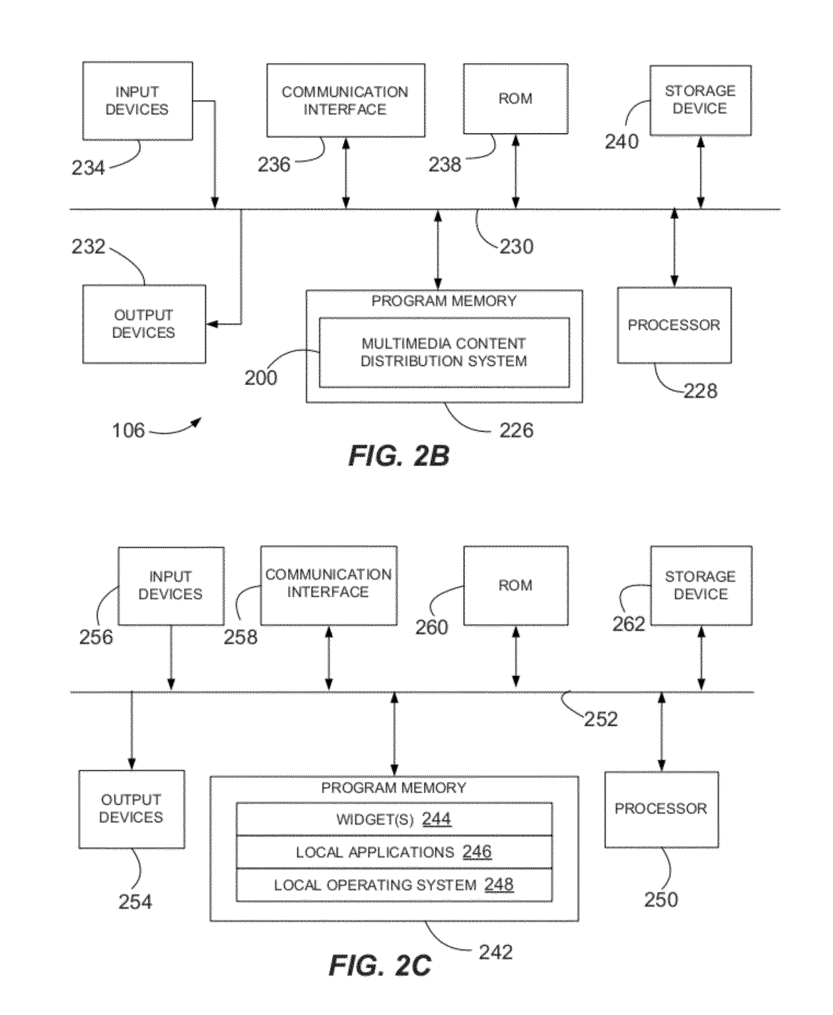

FIG. 2A is an illustration of an embodiment of a multimedia content distribution system 200. In this embodiment, the system 200 is comprised of a content management system 202, a data management service 208, an analytics and reporting service 210, a security service 212, a transaction payment processing service 214, a widget management service 216, an incentive management service 222 and an accounting service 218. The content management system 202 is comprised of three components, a widget builder resource component 204, a content management component 220, and a market management component 206. The content management component 220 is used for the uploading of multimedia content, the editing of metadata related to the content and the creation of compilations of content into marketable packages that can be associated with one or more web widgets. In addition to controlling the uploading, editing and creation of content compilations through the content management component 220, the content management system 202 also controls the processes applied to uploaded content files for virus scanning, file transcoding and file compression for storage in the cloud-based storage resource 124. The widget builder resource component 204 is used to create various marketing resources including new web widgets, buy buttons, links and preview clips. In one embodiment, the buy buttons, links and preview clips are each communicatively coupled to a web widget so that the selection or clicking on a button, link or preview clip causes the activation of a web widget Once these marketing resources are created, content owners can use them in viral distribution marketing campaigns to promote their content compilations. The market management component 206 is used by content owners to assign market rules and pricing terms to selected items included in a content compilation. In one embodiment, the items include individual songs, song releases, or entire song catalogues. In a different embodiment, the items include reports, physical merchandising paraphernalia (e.g., cups, t-shirts, hats, etc.), and other electronic goods.

The data management service 208 is used to maintain a lookup table for use in tracking the locations of stored multimedia content files in the cloud-based storage resource, transcoded variants of these files, compressed files including one or more copies of content files and transcoded files, and files storing usage statistics collected by one or more web servers from the web widgets, buy buttons, links, preview clips or other marketing resources which are created and distributed by content owners and third parties. The analytics and reporting service 210 in one embodiment is a subcomponent of the data management service 208 and is used to analyze compiled analytical data, transaction statistics and location statistics for the marketing resources used by content owners in promoting their multimedia contents over one or more networks. More specifically, the analytics and reporting service 210 compiles transaction statistics and location statistics arising from the viral distribution of web widgets and related purchase transactions initiated and completed over web widgets which have been distributed over such networks. In an alternative embodiment, the analytics and reporting service 210 is a stand-alone service which independently interacts with the data management service 208 and the one or more web servers comprising the widget management service 216 which are used for the tracking of web widgets and other marketing resources and the collection of usage statistics from these resources. The analytics and reporting service 210 also compiles statistics about the incentive program implemented using the incentive management service 222. In one embodiment, the statistics compiled by this service 210 are the number of sales, the number of times distributed widgets have been viewed, the number of times the widget has been shared, the location of the widgets as determined from geography and internet protocol address, and the number of times distributed widgets have made calls to the multimedia content distribution system 200.

The security software service 212 provides content owners, distributor clients and consumer clients with secured access to the multimedia content distribution system 200 and its operating infrastructure by implementing an authentication process to confirm that the credentials presented by a user (e.g., username and password) match a user identifier (a “UserID”) which is stored in the database maintained on the database server 110. The security service 212 also determines what functions, features and services an authenticated user is authorized to access. In one embodiment, firewall software is a component of the security service 212 and is used to restrict access to the application server 106 and other computing resources used as part of the operating environment for the multimedia content distribution system 200. The payment processing service 214 provides direct access to transaction processing resources for the completion of purchase transactions initiated by consumers who use web widgets to preview, purchase and download multimedia content. An order identifier (an “OrderID”) is generated by the payment processing service 214 for each completed purchase transaction and all OrderIDs are stored in the widget sales table which is in the database maintained on the database server 110. In one embodiment, the payment processing service 214 is provided by the Flexible Payment Service (FPS) offered by Amazon.com, Inc. The payment processing service 214 is used for the facilitation and execution of payment transactions using credit cards, debit cards or other bank account information. In addition to its role in facilitating the completion of purchase transactions, the payment processing service 214 makes payment of incentives to registered members who have shared web widgets or other portable content distribution devices that have been used for completed purchase transactions.

The widget management service 216 is implemented on one or more web servers and is used for the tracking of web widgets which have been distributed to and activated on Internet websites or on other accessible locations and resources over other networks. Once a web widget has been distributed or activated from a link, buy button or preview clip, it can be further distributed in a “viral” fashion to other online communities, websites, forums, etc. In one embodiment, the widget management service 216 is implemented on web servers which are co-hosted on the application server 106. In an alternative embodiment, the widget management service 216 is implemented on one or more independent web servers 136. In both embodiments, however, the widget management service is used for receiving and responding to requests for multimedia content received from web widgets. In addition, the web servers implementing the widget management service 216 also perform data collection and activity monitoring on deployed web widgets. The data collected by the web servers includes transaction statistics, location statistics, usage statistics and other pertinent market statistics for each web widget which has been created, activated and distributed over the Internet, mobile networks or other computer communication networks by the content owner or third parties, such as consumers and members of their online social networks. Once a web widget is activated, the web servers implementing the widget management service 216 compile the data statistics into one or more files which are stored in the cloud-based storage resource 124 and a reference to the stored data collection files is created in the lookup table maintained by the data management service 208 and associated with the multimedia content files and any related transcoded files which have been packaged with each web widget for which the statistics have been collected. In an alternative embodiment, the one or more data collection files including the data statistics are stored in the database on the database server 110 where the lookup table is maintained by the data management service 208.

In addition to tracking distributed web widgets, the widget management service 216 implements an incentive management service 222 that tracks sharing events and purchase events associated with the distributed web widgets. In implementing the incentive management service 222, the widget management service 216 generates a WidgetID for each widget created by the widget builder resource component 204, a WidgetAliasID, a WidgetAlias Universal Resource Locator (i.e., WidgetAlias URL), hypertext markup language (HTML) code including the WidgetAlias URL, and Javascript code including the Widget URL. A WidgetAliasID is created for a widget each time it is selected to be shared by a registered member to a third party. The WidgetAlias URL, the HTML code and the JavaScript code including the embedded WidgetAlias URL are generated as resources that can be used by registered members with the incentive management service 222 to efficiently distribute web widgets or other portable content distribution devices to application servers and websites (e.g., Facebook, Twitter, MySpace, Xing, Ning, Plaxo, Friendster, etc.) throughout the network 102.

One embodiment of a WidgetAlias URL is as follows: http://diymusicplatform.com/a/7kDXmwwYr0eaCp6cATGUxQ.html

One embodiment of the HTML code that is generated by the widget management service 216 for distribution of a web widget by a registered member in the incentive management service 222 is shown below:

<object width=“300” height=“300”><param name=“movie”
value=“http://diymusicplatform.com/a/
7kDXmwwYr0eaCp6cATGUxQ.swf”/><param name=“allowFullScreen”
value=“true”/><param name=“allowscriptaccess” value=“true”/><embed
src=“http://diymusicplatform.com/a/7kDXmwwYr0eaCp6cATGUxQ.swf”
type=“application/x-shockwave-flash” allowscriptaccess=“always”
allowfullscreen=“true” width=“300” height=“300”></embed></object>

An embodiment of the JavaScript code that is generated by the widget management service 216 for distribution of a web widget by a registered member in the incentive management service 222 is provided below:

<script type=“text/javascript”
src=“http://diymusicplatform.com/a/
7kDXmwwYr0eaCP6cATGUxQ/draw.js”></script>

The incentive management service 222 implements an incentive program based on specific incentives offered by the creator of the web widgets or other portable content distribution devices to stimulate viral distribution of the widget and increased numbers of purchases of the content associated with each distributed web widget. In implementing an incentive program, content owners and content distributors who create the widgets and devices determine what amount of incentive will be payable to sharing participants in the incentive program. Moreover, the amount of such incentives can vary depending on the content being promoted in any given web widget or portable content distribution device. The incentive management service 222 provides for the registration of members into the incentive program, an event management capability for managing and updating the widget sharing table and the widget sales table stored in the database on the database server 110, and a capability for dynamically updating and tracking earned incentives at each of several different levels of participation by registered members arising from registered share events. A “registered share event” is the sharing of a web widget or other portable content distribution device by a registered member with a third party. In one embodiment, registered members can earn incentives for sharing web widgets at each of three different levels of sharing. For example, the registered member may distribute a web widget or other portable content distribution device by placing the WidgetAlias URL in an email distribution to a select group of subscribers on a mailing list, or embed the HTML code or JavaScript code on webpages which are accessible from or within Facebook, Twitter or other social media platforms. If a consumer viewing the web widget or other portable content distribution device previews and purchases the content associated with the widget or device, then the registered member will earn an incentive. If the viewing consumer is also a registered member in the incentive management service 222, then the consumer may elect to distribute the widget or device to other individuals, who may in turn be registered members or who will register to become registered members to begin earning incentives from the sharing and purchasing activity arising from the shared widget or device. In an embodiment, the registered member who initially distributed the widget or device will be entitled to earn incentives in the incentive management program implemented by the incentive management service 222 at each of three different levels of distribution. Incentives can be earned from purchase activity at all levels of distribution regardless of whether the purchasers are themselves registered members. In an alternative embodiment, a registered viewing consumer who purchases content from the widget or content distribution device the consumer shares will also be eligible to earn higher incentives from purchase transactions arising from subsequent sharing of the widget or device. Only registered members, however, earn incentives even though any user can distribute the widgets or devices.

The accounting service 218 provides account transaction reconciliation for each content owner having an active account on the content management system 202. By using the accounting service 218, content owners can track the number and type of available content in their inventories of content files, the number of transactions performed relative to the total number of available content files, the number of transactions which have been returned for credit to consumers, the number of completed transactions, and revenue earned from completed transactions. The accounting service 218 also performs the crediting and debiting of registered member accounts for earned incentives resulting from registered share events.

FIG. 2B depicts an embodiment of an application server 106 operative to execute the multimedia content distribution system 200. This embodiment includes one or more input devices 234, a communication interface 236, a read-only memory 238, a storage device 240, a processor 228, a program memory 226 and one or more output devices 232. The program memory 226 in one embodiment is a random access memory. The storage device 240 in operative embodiments includes one or more floppy disks and conventional hard disks. The read-only memory 238 in operative embodiments includes one or more CD-ROMs, Flash ROMS and nonvolatile ROMs. Each of these components of the application server 106 is communicatively coupled to communication bus 230. Program memory 226 includes a multimedia content distribution system 200. In an embodiment, the communication interface 236 is operative to receive calls, data transfer requests and content purchase requests from distributed web widgets (or other portable content distribution devices) and to transmit metadata and content to the distributed widgets and devices for the previewing and downloading of content to client devices 130, 132, 134. The communication interface is also operative to receive sharing requests placed by users of the widgets and devices who are registered members in the incentive management service 222 and to transmit new WidgetAliasIDs for widgets and devices which are to be shared with third parties.

FIG. 2C illustrates the components of a network-based application server in the network 102. Similar to the application server 106 shown in FIG. 2A, this network-based application server is comprised of one or more input devices 256, a communication interface 258 that is operative to communicate with the application server 106, a read-only memory 260, a storage device 262, a processor 250, a program memory 242 and one or more output devices 254. The program memory 242 in one embodiment is a random access memory. The storage device 262 in operative embodiments includes one or more floppy disks and conventional hard disks. The read-only memory 260 in operative embodiments includes one or more CD-ROMs, Flash ROMS and nonvolatile ROMs. Each of these components is coupled to a communication bus 252 to facilitate inter-component communication. In one representative embodiment, the program memory 242 includes one or more web widgets 244 (or other portable content distribution devices), local software applications 246 and a local operating system 248. The network-based application server in one embodiment is a server used to operate social media platforms such as Facebook, Twitter, Flickr, Xing, Bing, etc. where users can create and post their own content, including WidgetAlias URLs which point to webpages where specially created code (e.g., the HTML code or JavaScript code included references to the WidgetAlias URL) is embedded to promote content associated with web widgets or other portable content distribution devices. Thus, the local applications 246 in an embodiment are the applications required to execute a social media platform and the local operating system is the operating system required to enable the platforms to be fully operable on a network-based server.

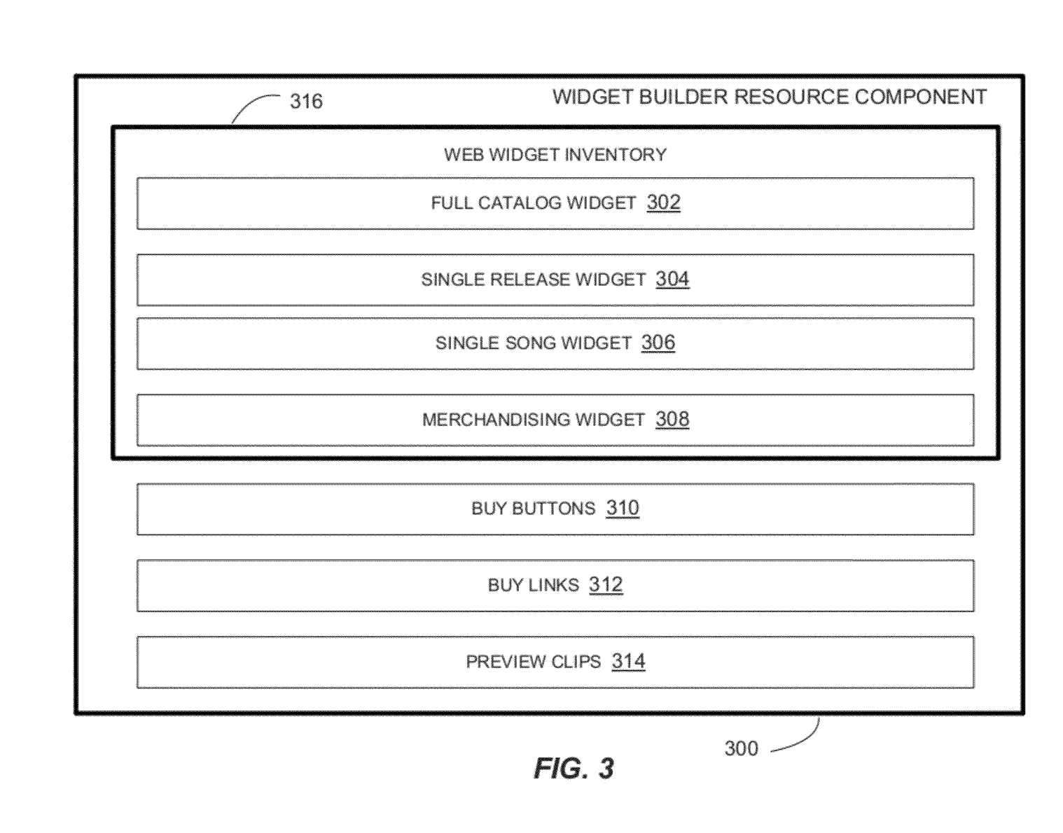

FIG. 3 depicts an embodiment of a widget builder resource component. The widget builder resource component 300 is used to create an inventory of “web widgets” 316, buy buttons 310, buy links 312 and preview clips 314. In an embodiment, the web widget inventory 316 includes services for creating web widgets for packages of marketable multimedia content including, in one embodiment, full catalogs of digital music content, single releases of digital music content and single song digital music content. The widget builder resource component 300 is also used to create a merchandising widget 308 to promote a content owner's physical goods and related materials as marketing merchandise. Examples of such physical goods are coffee mugs, t-shirts, hats, jackets, etc. In the present embodiment, the web widgets pertain to musical content which is often compiled in the form of musical catalogs, musical releases, and single songs. A full catalog widget 302 is used for the promotion of the full musical catalog of a content owner. In one embodiment, the full catalog widget 302 is used to execute a video clip that provides a preview of the content in a content owner's inventory in the multimedia content distribution system 200 that is packaged with the web widget. The web widgets 302, 304, 306, 308 are also used to facilitate electronic commerce transactions involving the purchase or licensing of multimedia content, such as musical selections as shown in this embodiment, in the specific groupings desired (i.e., catalog, release, or single song).

A single release widget 304 is used to promote a single musical release of a content owner from content stored in a content inventory of the multimedia content distribution system 200 in an embodiment. A single song widget 306 is used to promote a single song provided by a content owner in an embodiment. The merchandising widget 308 is used to promote the merchandise or physical goods that a content owner may choose to promote alone or in association with one or more multimedia content files in an embodiment. The merchandising widget 308 is used when a content owner seeks to create a fully custom content compilation which may include promoted merchandise or physical goods (e.g., cups, hats, t-shirts, etc.), a subset of content from specific releases as well as other content from the content owner's catalogue which is not included in any specific release. The buy buttons 310 are generated by content owners using the widget builder resource component 300 and linked to web widgets. The buy buttons 310 can be customized and distributed to online resources on the Internet, on mobile communication networks or on other computer networks for use in promoting the various groupings of multimedia content available from a content owner. Once a buy button 310 is clicked or selected by a consumer, it will activate its linked web widget and take the consumer to a checkout screen in the web widget. The buy links 312 are Hypertext Transfer Protocol (HTTP) links that are created by content owners for widespread, viral distribution on the Internet, on mobile communications network or on other networks that enable consumers to click on such links to activate web widgets associated with these links that promote their multimedia content files and related merchandise. The preview clips 314 created in the widget builder resource component 300 are linked to web widgets but are designed to automatically execute video and audio clips in the browsers of consumer client devices 130, 132, 134 to enable those consumers to preview multimedia content and to make informed choices about the multimedia content they may elect to purchase and download to their client devices 130, 132, 134, or to further distribute to third parties in the social networks of these consumers or in other online communities. Upon completion of an executing video clip, the linked web widget which will have been activated at the start of execution of the preview video clip will be displayed in the browsers of the consumer client devices 130, 132, 134 to aid the consumer in making a purchase or distribute decision.

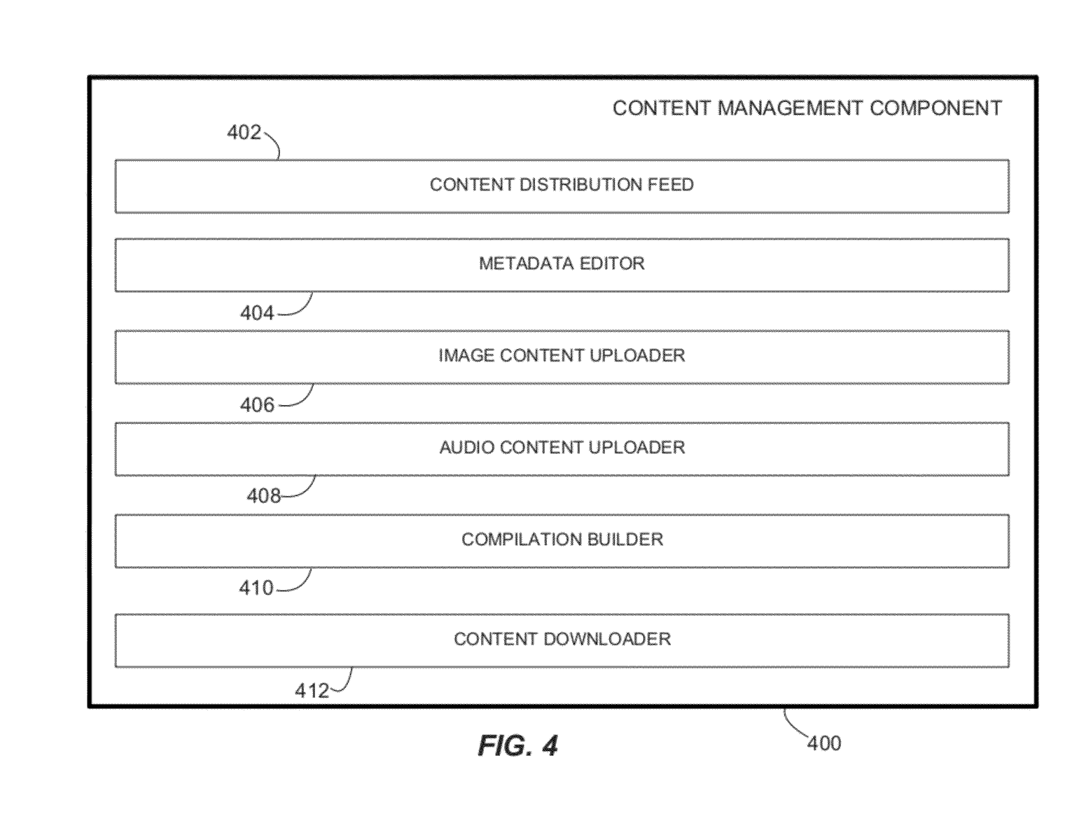

FIG. 4 illustrates an embodiment of a content management component 400. The content management component 400 is comprised of several services. The content distribution feed 402 is a service that enables content owners to request and receive distribution feeds from content distributors. The content provided by content distributors to content owners through such feeds is used to automatically update and supplement the content inventories of content owners in the content management system 202. The metadata editor 404 is a service that enables content owners to edit the metadata associated with multimedia content files. In one embodiment, the type of metadata that can be edited includes information pertaining to the musical content of a content owner such as title, artist name, release date, genres, catalogue number and Universal Product Code. Image Content Uploader 406 is a service that uploads, store and registers image files provided by content owners for use in creating marketable compilations of content associated with web widgets. In one embodiment the types of image files which can be uploaded using the Image Content Uploader 406 are GIF files, JPEG files and TIF files. Audio Content Uploader 408 is used for uploading audio files. In an embodiment the audio file types that can be uploaded using the Audio Content Uploader 408 include WAV files and MP3 files. The compilation builder 410 is used by content owners to create custom compilations from the content available in the content inventories managed by the content management system 202. In an embodiment, each content compilation created using the compilation builder 410 is associated with a web widget that will be distributed using the web distribution service 216 to consumers on the Internet, mobile communications networks, or other computer communications. Lastly, the content downloader 412 is used for controlling the downloading of the custom content compilations created by content owners which are packaged with and promoted through web widgets. Upon receipt of a content download request from a web widget, the content downloader 412 initiates and controls the process of retrieving the packaged content compilations associated with and promoted through the web widget from the cloud-based storage resource 124 or other storage in the multimedia content distribution system 200, and it also controls the process of downloading the retrieved content compilations to a client device 130, 132, 134.

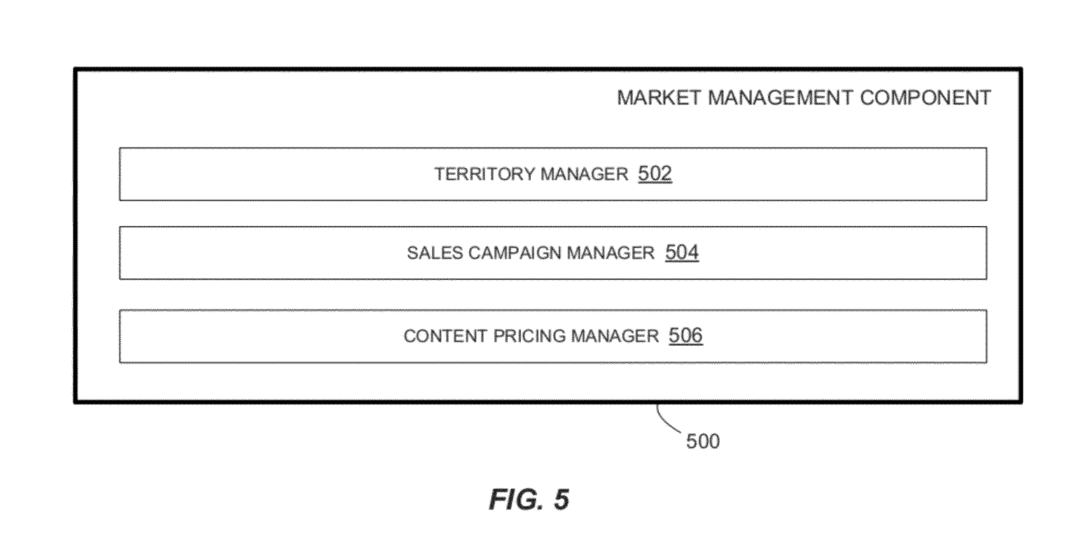

FIG. 5 illustrates the services provided in an embodiment of a market management component 500. As shown, one service is a territory manager 502 which is used by content owners to set the sales parameters and the timing of sales campaigns relating to specifically available content from a content owner in different geographic regions of the world. For example, a content owner may choose to provide a subset or only a particular release version of certain musical content for sales and marketing campaigns in Spain, Germany or France. While in other parts of the world, the content owner may choose to set different territorial restrictions on the availability of their content such as limiting the availability of musical content only to earlier releases rather than later releases in an entirely different part of the world, such as South America or in specific South American countries. The sales campaign manager 504 is another service provided in an embodiment of the market management component 500 that enables content owners to enable and disable sales campaigns by specified dates. The content pricing manager 506 is a service that allows content owners to set the pricing of particular files by file type. Although not limited only to musical content, in one embodiment the content pricing manager 506 is used to set pricing for MP3 file types and for WAV file types. Although the present embodiment is described with respect to the use of musical content stored in MP3 and .WAV file formats, the use of a content pricing manager 506 is not limited to the pricing of content for musical files or even to the pricing of files in these two types of file formats, but can be applied broadly to the pricing of content in image files, video files, audio book files, or video game files as well as in other file types and file formats of multimedia content generated by content owners.

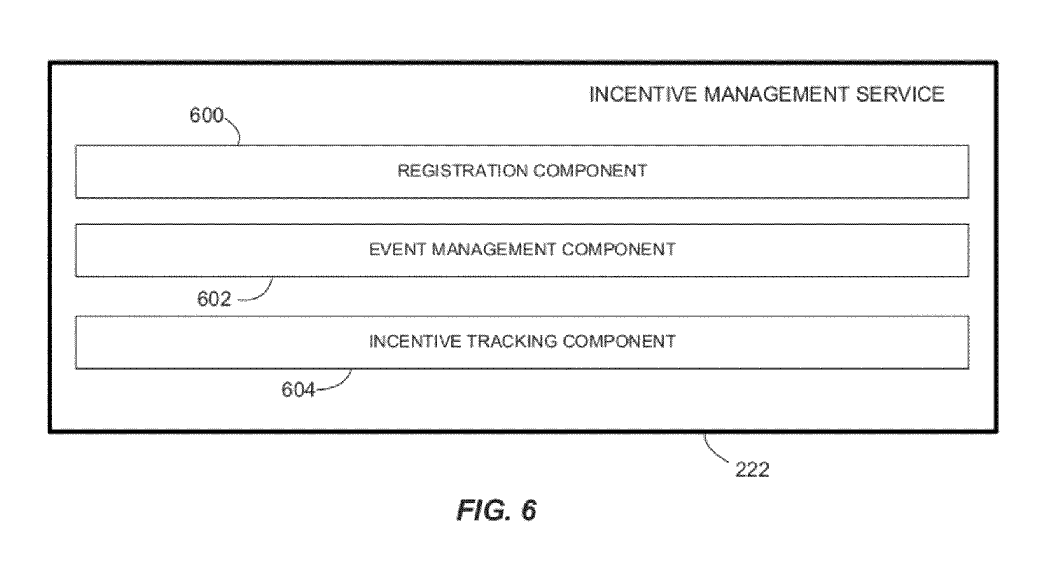

FIG. 6 is an illustration of an incentive management service 222 in an embodiment. The incentive management service 222 includes a registration component 600, an event management component 602 and an incentive tracking component 604. The registration component 600 is used to create new user profiles and to have the widget management service 216 generate a new user identifier and a new username and a new password for new registrants in an incentive management program. The event management component 602 manages and updates the information in a widget sharing table and a widget sales table which are stored in the database on the database server 110. The widget sharing table tracks the sharing of widgets or other portable content distribution devices which are distributed by registered members. A “registered member” is a registrant with an active account in the registration component 600 of the incentive management service 222. The widget sharing table is stored in the database and is comprised of multiple records. In one embodiment, the widget sharing table stores one or more widget alias identifiers (“WidgetAliasIDs”), a widget identifier (a “WidgetID”) and up to three different UserIDs. In an embodiment, the three user identifiers are stored in three different locations in the table and these locations represent the respective share levels of the registered members who have distributed copies of the widget having the associated widget identifier. Although each copy will have its own widget alias identifier, all copies of the widget will be associated with the widget identifier which was generated at the time the widget was first created using the widget management service 216. The widget sales table tracks all purchase transactions associated with each distributed widget or other portable content distribution device. At the time a widget is distributed, a new widget alias identifier is generated using the widget management service 216 and a user identifier is stored in a location in the widget sharing table corresponding to the sharing level of the participating registered member who is distributing the widget. The event management component 602 insures that each newly generated WidgetAliasID is stored in both the widget sharing table and the widget sales table and that the UserID is stored in the location representing the share level of the registered share event in the widget sharing table. The event management component 602 also updates sharing levels of registered members in the widget sharing table after each registered share event. A “registered share event” is a distribution of a widget or other portable content distribution device by a registered member in the incentive management service 222. When a widget is first shared, the UserID of the registered member who shares or otherwise distributes the widget will be stored in a location representing a Level1 sharing level and the registered member is deemed a “Level1 sharing participant.” If the widget is subsequently shared by a user who viewed or received the initially distributed widget, then the UserID of this user will be stored in the location representing the Level1 sharing level and if this user is a registered member then the user will be deemed a “Level1 sharing participant” and the UserID of the registered member who first shared the widget will updated to the location for a Level2 sharing level and this first sharing registered member will be deemed a “Level2 sharing participant.” In an embodiment, this process of tracking, storing and updating successive distributions of shared widgets each having the same WidgetID continues until there are three levels of tracked sharing in the widget sharing table. In each case, each WidgetAliasIDs for each copy of the widget associated with the original WidgetID is stored in the widget sharing table. In addition to maintaining sharing relationships in the widget sharing table, the event management component 602 also updates the widget sales table with new OrderIDs for each purchase transaction associated with each WidgetAliasID. The incentive tracking component 604 credits the sharing accounts of registered members with incentives earned from purchase transactions arising from registered share events. Upon completion of a purchase transaction through a widget, the payment processing service 214 will report the completed transaction to the incentive tracking component 604 and the applicable incentive will be determined by the incentive tracking component 604 and then the final result will credited to the sharing account of a registered member. The incentive track component 604 also reports determined credits to the accounting service 218 and provide earned credit information statistics to the analytics and reporting service 210. The amount and type of incentive applied to a sharing account can vary depending on the specific incentives offered by the creator of the incentive program. In this manner, content creators who wish to incentivize the promotion of specific content in their portfolios can offer enhanced or more attractive incentives for the content relative to incentives offered on other content available from the content creators.

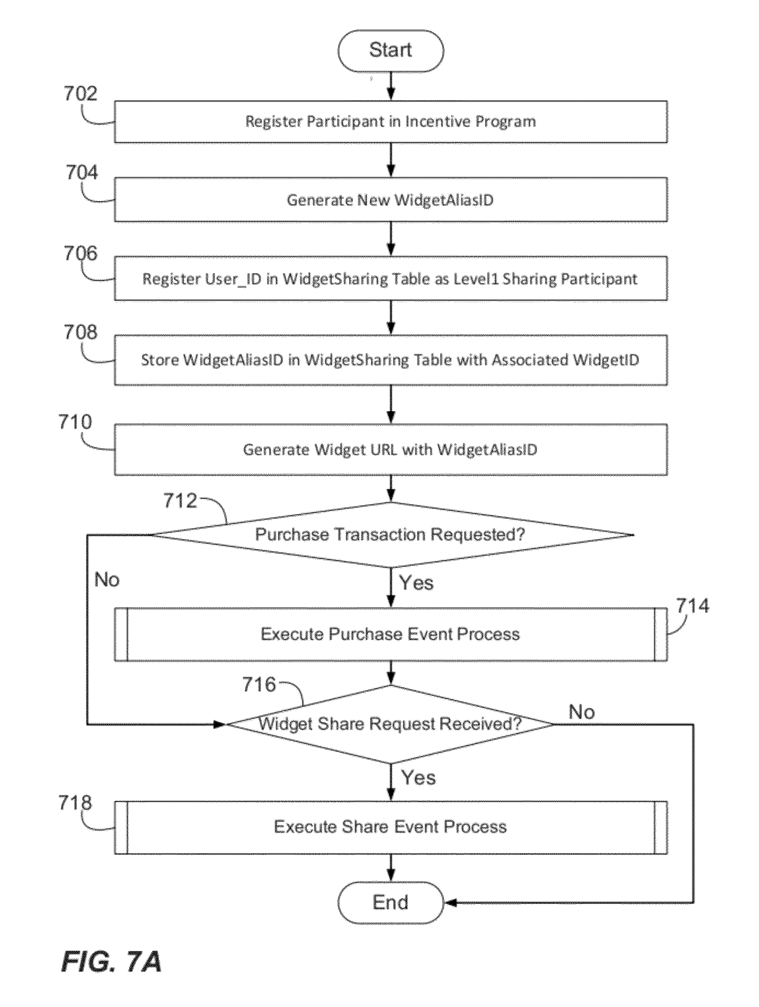

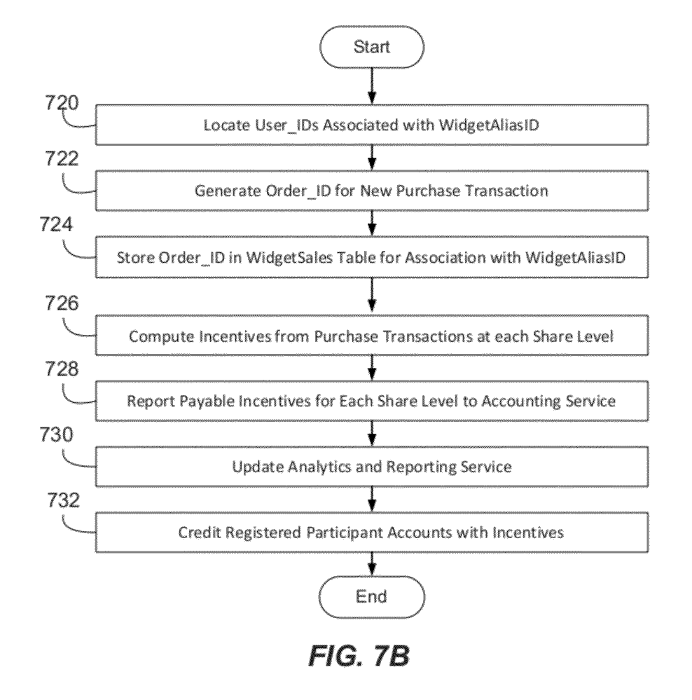

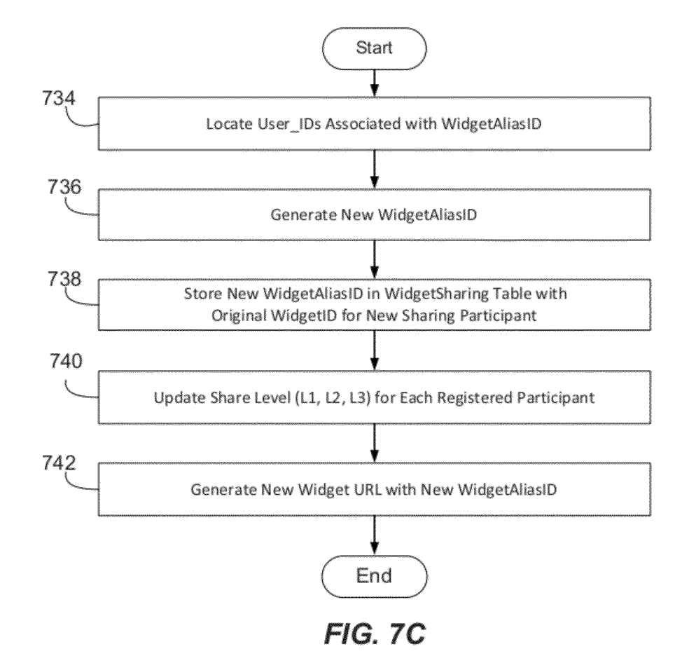

FIG. 7A is an illustration of a method for incentivizing social commerce in one embodiment. The method begins at step 702 with the registration of a new participant in an incentive program implemented using the incentive management service 222. Upon registration, a user profile will be created in the incentive management service 222, a new UserID will be created by the widget management service 216 and stored in the database in the database server 110 and new security credentials (i.e. a new username and a new password) will be generated for the new registered user. After registration, a new WidgetAliasID will be generated as shown in step 704 and the User ID will be registered in the widget sharing table as a Level1 sharing participant in the incentive program, as shown at step 706. Afterwards, the WidgetAliasID will be stored in the widget sharing table with the Widget ID for the widget that is to be shared. All widgets generated using the multimedia content distribution system 200 will have a WidgetID and this identifier will be stored in the widget sharing table. However, new WidgetAliasIDs will be generated at the time of each new registered share event and as sharing activity increases the number of widget alias identifiers will also increase and they will be stored in the widget sharing table and associated with the WidgetID, as shown at step 708. After storing the WidgetAliasID in the widget sharing table, a Widget Alias Universal Resource Locator (a “WidgetAlias URL”) will be generated that includes the WidgetAliasID, as shown at step 710. The WidgetAlias URL is used for distribution of the widget or other portable content distribution device to websites and locations on the Internet or, more generally, over a network 102 of computing and communication resources. In an alternative embodiment, in addition to generating a WidgetAlias URL, certain HTML code and JavaScript code will be generated that is also available for use by registered members to distribute the web widget. The HTML code and the JavaScript code can be embedded in web pages created by widget distributors and content promoters as a means for gaining more visibility for the content associated with a widget. As consumers use the Internet and seek access to the content associated with the distributed widgets, a request may be received for a purchase transaction pertaining to one or more of the content items associated with a widget, as show at step 712. If a purchase transaction is requested from a widget, then a pre-defined purchase event process will be executed, as shown at step 714. Upon completion of the purchase event process, the incentive management service 222 will check to confirm whether there has been a request to share the widget, as shown at step 716. If a share request is received, then a pre-defined share event process will be executed, as shown at step 718 and the process will then conclude. Returning to step 712, if no purchase transaction is requested then the incentive management service 222 will seek to determine whether a share request has been received for continued distribution and sharing of the web widget, as shown at step 716. If no share request is received then this stage of the process will end.

FIG. 7B is an illustration of a pre-defined purchase event process in an embodiment as identified in FIG. 7A. In this process, after receipt of a purchase request, the widget management service 216 locates UserIDs associated with the WidgetAliasID for the widget from which the request has been received, as shown at step 720. Once the purchase transaction has been completed with the payment processing service 214, an OrderID is generated for the purchase transaction, as shown at step 722, and it is stored in a widget sales table in the database on the database server 100. The OrderID is stored in the widget sales table to preserve the association between the specific copy or instance of a shared widget, as represented by its WidgetAliasID, and the purchase transaction, as shown at step 724. After storing the OrderID in the widget sales table for association with the corresponding WidgetAliasID, the earned incentives are computed from the purchase transaction for each share level having a UserID in the widget sharing table associated with the WidgetAliasID, as shown at step 726. In one embodiment, the earned incentives payable to a registered member who distributes a widget without purchasing content associated with the widget are lower than the earned incentives payable to a registered member who both distributes the widget and makes one or more purchase transactions using the widget. The earned incentives in the former case are referred to as “sharer incentives” and the earned incentives in the latter case are referred to as “buyer incentives.” After computing the earned incentives, payable incentives at each share level will be reported the accounting service 218, as shown at step 728 and the analytics in reporting service 210 will be updated to reflect the statistics associated with the new purchase transaction, as shown at step 730. After updating the analytics and reporting service 210, the sharing accounts of registered members will be credited with the earned incentives, as show as step 732, and the process ends.

FIG. 7C illustrates an embodiment of the pre-defined share event process identified in FIG. 7A. This process commences with the locating of UserIDs associated with a WidgetAliasID, as show as step 734, followed by the generation of a new WidgetAliasID, as shown at step 736. A new WidgetAliasID is generated each time a widget is shared by a registered member. The new WidgetAliasID is stored in the widget sharing table with the original WidgetID for the new sharing participant, as shown at step 738. New WidgetAliasIDs will be generated each time a widget is shared and each new WidgetAliasID will be stored in the widget sharing table with the original widget identifier and the share level of each sharing participant will be updated. Accordingly, as shown at step 740, the share level of each registered member participating in the incentive program (i.e., a “registered participant”) will be updated and a new WidgetAlias URL with the new WidgetAliasID will be generated, as shown at step 742. The new WidgetAlias URL is used for the sharing of the widget by the sharing registered participant. In an alternative embodiment, HTML code and JavaScript Code are generated which include the new WidgetAlias URL and the code is used for embedding into web pages for promotion of the content associated with the widget which has been shared by the registered participant. After generating the WidgetAlias URL, the pre-defined share event process ends.

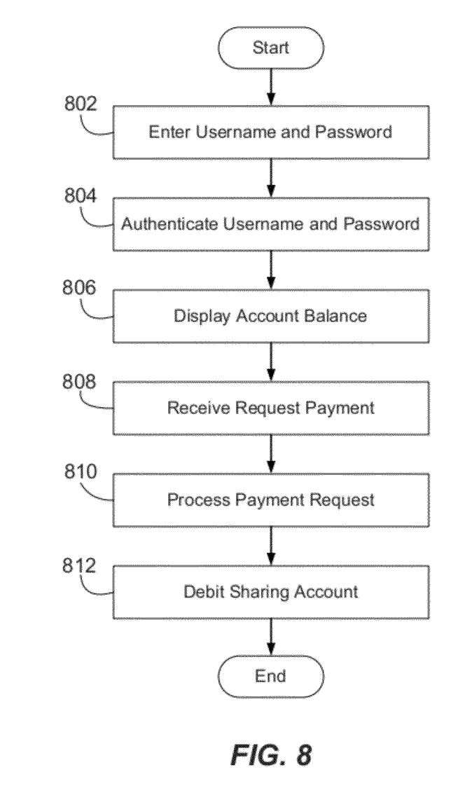

FIG. 8 is an illustration of a payment event process followed by registered participants who seek to withdraw the value of their earned incentives in the incentive program implemented using the incentive management service 222. In this embodiment, a user enters a username and password, as shown at step 802, and the username and password are authenticated by the security service 212, as show at step 804. After authentication, the user's current account balance from earned incentives is determined and displayed in the browser of the user's client device by the incentive management service 222, as shown at step 806, and a user will then be presented with a button or other selection means to place a request for payment. Upon receipt of the request for payment, as shown at step 808, the payment request is processed, as shown at step 810, by the payment processing service 214 and the user's sharing account is debited, as shown at step 812. After debiting the registered participant's sharing account, the payment event process ends. A record of the debiting of the sharing account will be sent to the accounting service 218 to maintain current and accurate sharing account balances for the registered member.

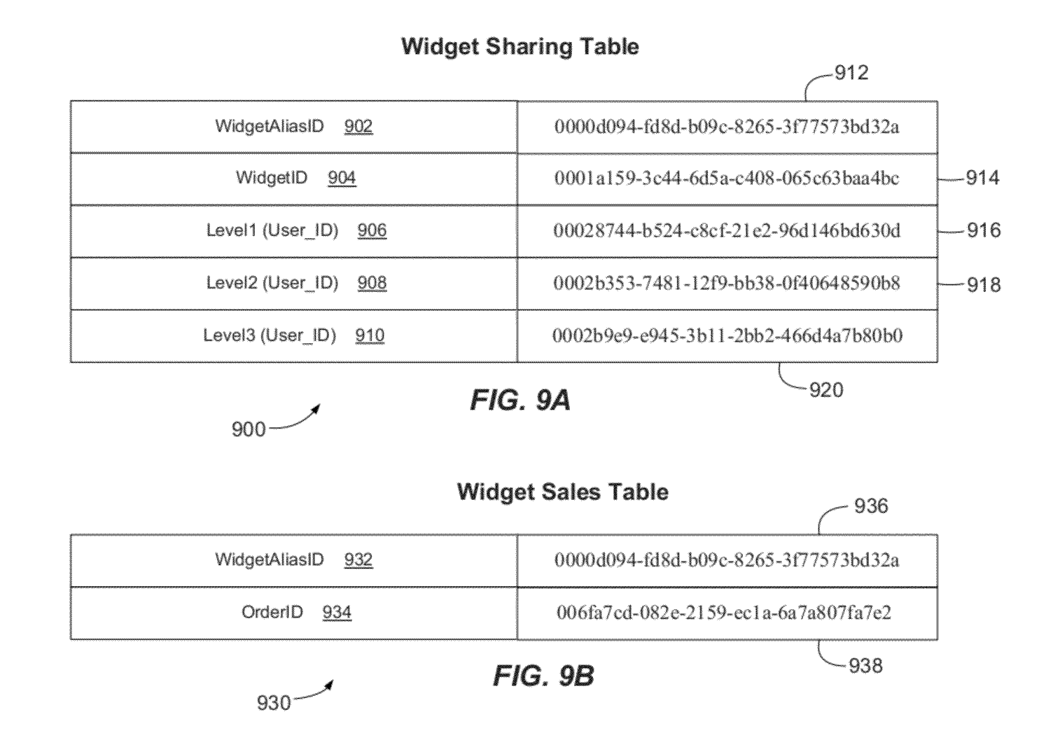

FIG. 9A is an illustration of a widget sharing table as stored in the database on the database server 110 in an embodiment. This embodiment of the widget sharing table includes several records, each record having two fields. The first record is for storing a WidgetAliasID 902 and it encoded representation. In this representative example, the alphanumeric code representing a WidgetAliasID is shown in block 912. The second record in this table is for storage of a WidgetID 904 and an example is shown in block 914. The third record stores the Level1 share level participant's UserID 906 and an illustrative example of this type of identifier is shown in block 916. The next record is for storing the UserID 908 of the Level2 share level participant and an example is shown in block 918. The next record is for storing the UserID 910 of the Level3 registered participant and an example is shown in block 920. Although the illustrated embodiment of the widget sharing table 900 includes five records with three registered participants, a new record will be created in the widget sharing table 900 to store new WidgetAliasIDs each time a new WidgetAliasID is created by a registered member.

FIG. 9B is an illustration of a widget sales table 930 as stored in the database and on the database server 110 in an embodiment. The widget sales table 930 includes two records, one record for a WidgetAliasID 932 with an example shown in block 936 and a second record for the OrderID 934 with an example shown in block 938. In the present embodiment, the identifiers stored in the widget sharing table 900 and the widget sales table 930 are alphanumeric globally unique identifiers (“GUIDs”) of equal length.

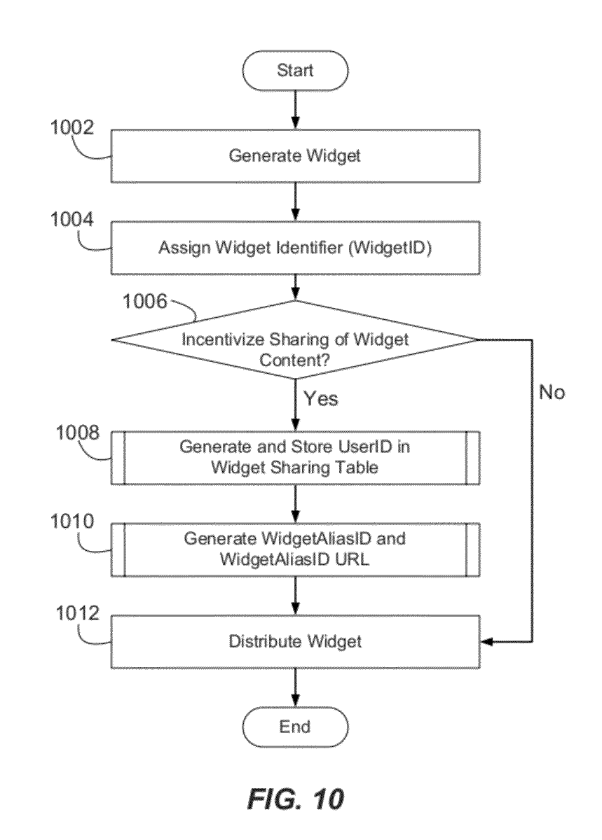

FIG. 10 is an illustration of a method for generating and distributing a widget for incentivized sharing. This method commences with the generation of a widget using the widget builder resource component 204, as shown at step 1002, followed by the generation and assignment of a WidgetID for the widget, as shown at step 1004. After generation of the widget, the incentive management service 222 query the widget creator to determine whether the widget is to be part of an incentivized sharing program, as shown at step 1006. If the widget creator elects to incentivize sharing of the widget and its associated content, then the incentive management service 222 will generate a UserID and store it in the widget sharing table in the database on the database server 110, as shown at step 1008. Afterwards, a WidgetAliasID and a WidgetAliasID URL will be generated to enable distribution of the widget to one or more network-based application servers on the Internet or over other networks 102, as shown at step 1010. After generation of the WidgetAliasID and the WidgetAliasID URL, the new widget will be distributed over the network 102, as shown at step 1012, once the distributed WidgetAliasID URL is clicked and the associated widget activated for execution on a network-based application server. In an alternative embodiment, concurrent with the generation of a WidgetAliasID URL, HTML code and JavaScript code including an embedded reference to the WidgetAliasID URL will performed to enable the widget creator to distribute the WidgetAlias URL independently or as part of certain HTML code or JavaScript code which can be embedded in specially created web pages on the Internet.

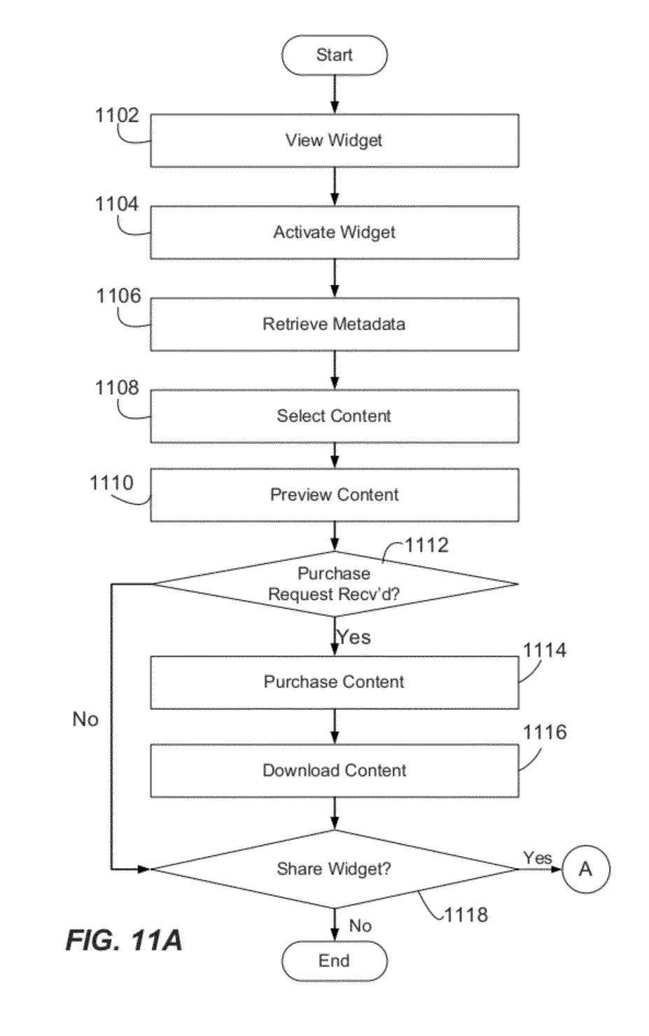

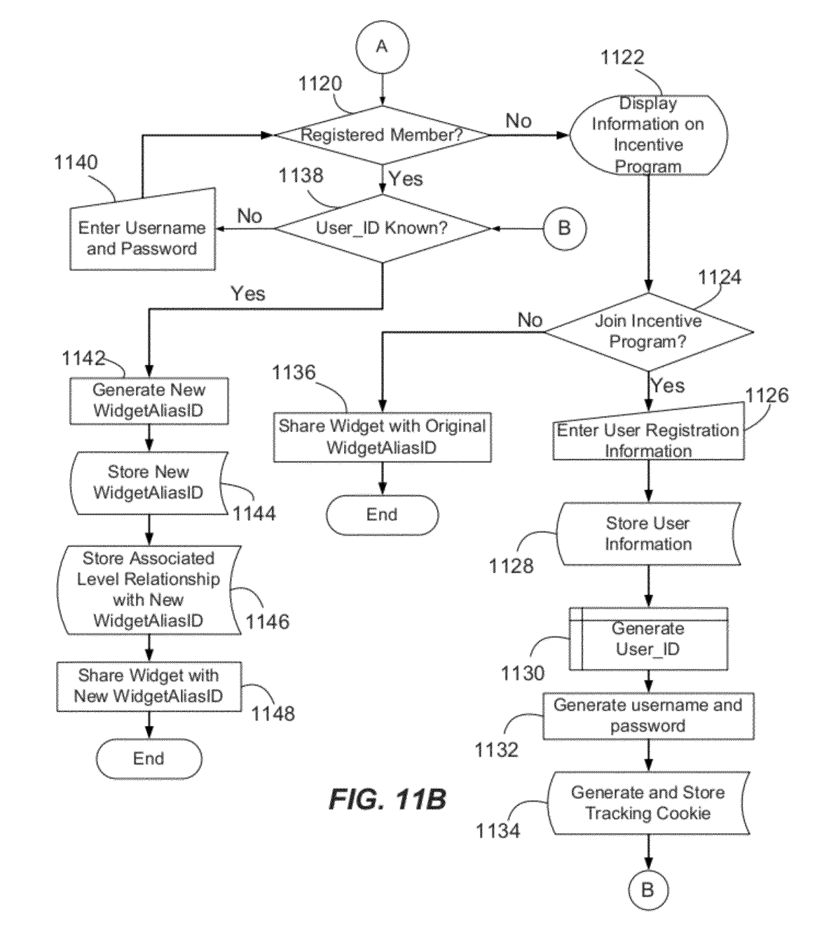

FIG. 11A is an illustration of a method of using a widget for incentivized social commerce in an embodiment. This method begins with a consumer or user viewing the widget, as shown at step 1102, and then activating the widget, as shown at step 1104, to thereby retrieve the metadata associated with the widget's contents, as shown at step 1106. In one embodiment, the metadata associated with the content in a widget includes information such as content title, artist name, release date, genres, catalogue number and Universal Product Code. After retrieval of the metadata, the user can select one or more content items, as shown at step 1108, and preview portions of the content, as shown at step 1110. After previewing the contents, the user can place a purchase request within the widget, as shown at step 1112, and a call will be made to the multimedia content distribution system 200 to process the purchase request to enable the purchasing of selected content, as shown at step 1114. After purchasing the content, the content is downloaded to the user's client device, as shown at step 1116. The incentive management service 222 will then actively monitor the widget to determine whether the request is placed to share the widget and its associated content, as shown at step 1118. The process determines whether a widget is to be shared as step 1118 by monitoring for the receipt of a share request from the web widget. If no such share request is received, then this method of using the widget ends. If a share request is received, then the method proceeds according to the steps set forth in FIG. 11B.

FIG. 11B is a continuation of the method of using a web widget for incentivized social commerce in an embodiment. This figure also sets forth a method for registering new members in an incentive program implemented using the incentive management service 222. In this embodiment, after receipt of a share request, as shown at step 1118 in FIG. 11A, the incentive management service 222 will seek to determine whether the user is a registered member in the incentive program, as shown at step 1120. If the user is not a registered member in the incentive management service 222, information will be displayed in the browser of the user's client device 130, 132, 134 which provides an overview of the incentive program, as shown at step 1122. An invitation will be extended to join the incentive program, as shown at step 1124, and if the invitation is accepted, the user will be prompted to enter the user's registration information. as shown at step 1126. The registration information includes at a minimum the user's name, address, preferred username and desired password. The user's registration information is then stored in the incentive manager service 222, as shown at step 1128, and a UserID will be generated and stored in the database in hosted on the database server 110 using a predefined process implemented in the incentive management service 222, as shown at step 1130. The incentive management service 222 also generates a username and password, as shown at step 1132, and a tracking cookie that is stored on the user's client device 130, 132, 134, as shown at step 1134. Afterwards, the method proceeds to reconfirm whether a UserID is known for the current user, as shown at step 1138. If a UserID is known from the stored tracking cookie, then a new WidgetAliasID is generated, as shown at step 1142, and the new WidgetAliasID is then stored in the widget sharing table in the database on the database server 110, as shown at step 1144. The storing of the WidgetAliasID in the widget sharing table forms an association between the WidgetAliasID, the original WidgetID and the user's UserID in the widget sharing table. At the time the WidgetAliasID is stored in the widget sharing table, the UserID will be copied from its location in the database and stored in the widget sharing table to establish the association between the UserID, the original WidgetID and WidgetAliasID. The UserID is stored in the location in the widget sharing table for a Level1 share level participant, as shown at step 1146. Once the location in the widget sharing table is established, the current user will be permitted to share the widget with the new WidgetAliasID in a manner permitting incentivized promotion of the widget's content, as shown at step 1148. This method ends once the registered share event occurs. Returning to step 1138, if no UserID is known for lack of a stored tracking cookie, then the user will be prompted to enter a username and password, as shown in step 1140, so that the user can be verified by the incentive management service 222 as a registered member in an incentive program, as shown at step 1120. Likewise, after a user is invited to join an incentive program, as shown at step 1124, if the user declines the invitation and still seeks to share the web widget, then the widget will be shared with the original WidgetAliasID, as shown at step 1136, and this user will not be entitled to earn any incentives arising from the shared distribution of the widget.

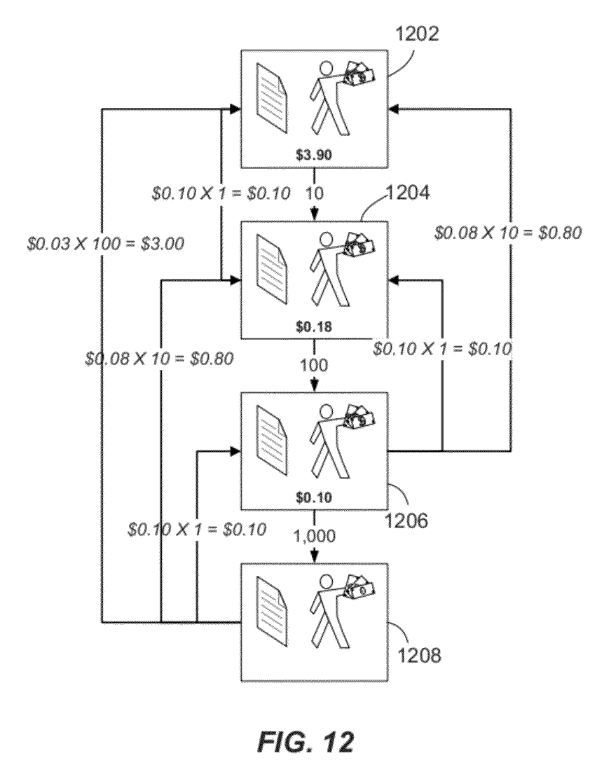

In each of the following illustrations shown in FIGS. 12, 13 and 14, illustrative examples of an operative incentive program implemented using the incentive management service 222 are shown. Successive level of sharing are shown in a top-down hierarchical manner to illustrate how incentives are earned. However, the incentivized social commerce enabled herein permits any registered member at any level of sharing to share widgets or other portable content distribution devices to other registered members without rigidly fixing their sharing level or position in the distribution model. Therefore, a Level1 share level participant who shares a widget with a user at a second level of sharing can be a Level2 share level participant if the user that receives the Level1 participant's widget shares a different widget with the Level1 participant. The social commerce enabled from use of the incentive management service 222 between and among sharing participants permits incentives to be earned regardless of a sharing participant's level for purchase transactions completed from any widget or other portable content distribution device so long as each sharing participant is a registered member in an incentive program implemented using the incentive management service.

FIG. 12 is an illustration of a series of incentivized transactions using an incentive management service in an embodiment. In this series of transactions, there is a Level1 share level participant, as shown in box 1202, who is both a registered member and a purchaser of content promoted within a web widget. This participant distributes the web widget to ten persons, as represented by box 1204. Each of those individuals later share the web widget with ten other individuals for a total number of 100 persons who receive the shared web widget, as represented by box 1206. These 100 recipients then share the web widget with 10 additional individuals each and their social network is as represented by box 1208. As illustrated in this example case, the web widget that was originally created by the individual shown in box 1202 has been distributed to 1000 individuals (represented by box 1208). As both a registrant in an incentive program and a purchaser of content from the shared widget, the Level1 share level participant shown in box 1202 is entitled to receive incentives from purchase transactions completed at each of the succeeding levels of users, as shown and represented by boxes 1204, 1206 and 1208. In this example, the incentive program offered by the artist or creator of the widget earns the Level1 share level participant an incentive of $0.10 from a purchase transaction completed by an individual at the second level of sharing, as shown in box 1204. The registered participant in box 1202 also earns incentives from purchase transactions completed by consumers at the second level of sharing as represented by box 1206 in the amount of $0.80. At the third level of sharing, the Level1 share level participant (shown in box 1202) earns an incentive of $3.00 for purchases completed by consumers at the third level of sharing, as shown in box 1208. As a result, the total of the earned incentives for the Level1 share level participant equal to $3.90. Since the individuals in the second level of sharing (represented in box 1204) also registered for the incentive program and completed purchase transactions they too will earn incentives. As shown in this example, the participants at the second level of sharing earn an incentive equal to $0.10 from purchases completed by registrants at the third level of sharing shown in box 1206. The Level2 share level participants shown in box 1204 also earn incentives from completed transactions made by those at the second level of sharing relative to their position (shown in box 1208) in this incentive program and the incentives earned equal to $0.80. At the third level of sharing as shown in box 1206 the participants earn incentives from completed purchase transactions from those at the fourth level of sharing as shown in box 1208, which in this example equal to $0.10.

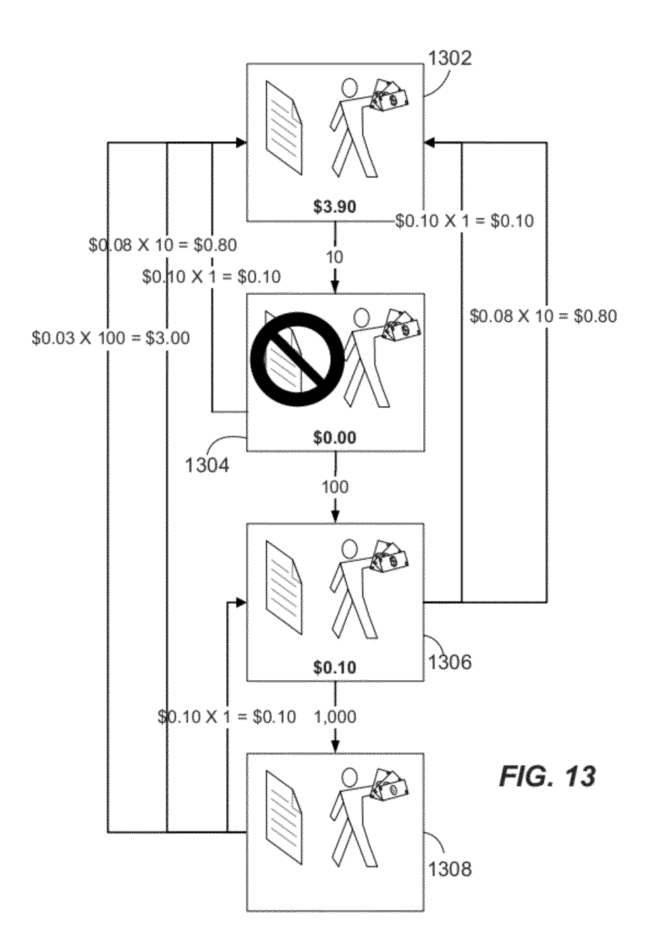

FIG. 13 is an illustration of an example of incentivized transactions involving users of widgets or portable content distribution devices who are not registered in the incentive program. In these transactions, the Level1 share level participants shown in box 1302 have registered to participate in the incentive program and have completed purchase transactions. The individuals at the second level of sharing shown in box 1304 are not registered but have completed purchase transactions using the widget which was shared with them by the Level1 share level participants shown in box 1302. At the third level of sharing, the participants are registered in the incentive program and have completed purchase transactions, as shown in box 1306. At the fourth level of sharing, the participants are registered in the incentive program and have completed purchase transactions, as shown in box 1308. Unregistered participants do not earn incentives from purchase transactions arising from widgets or other portable content distribution devices they share, but their purchase transactions do generate earned incentives for the registered share level participants in each level above the non-registered users. Additionally, the incentives the non-registered users would otherwise have earned flow to the registered participants in the sharing levels above the non-registered users. In the illustrated example, the earned incentives for individuals shown in box 1304 at the second sharing level are zero. Furthermore, the Level1 incentives which the non-registered users forego are paid to the registered participants (shown in box 1302) who shared the widget with the non-registered users, which in this case equal $0.10 and $0.80 for purchases transactions completed on the third and fourth sharing levels. The earned incentives for registered participants at the third level of sharing is $0.10 since they have registered and qualified to earn incentives from purchase transactions completed by those at the fourth level of sharing as shown in box 1308. As both registered members and purchasers in the incentive program, the registered participants at the first level of sharing shown in box 1302 are qualified to receive incentives equal to $3.90 from purchases completed at all three successive levels of sharing plus the incentives which would otherwise have been earned by the non-registered users at the second level of sharing (as shown in box 1304).

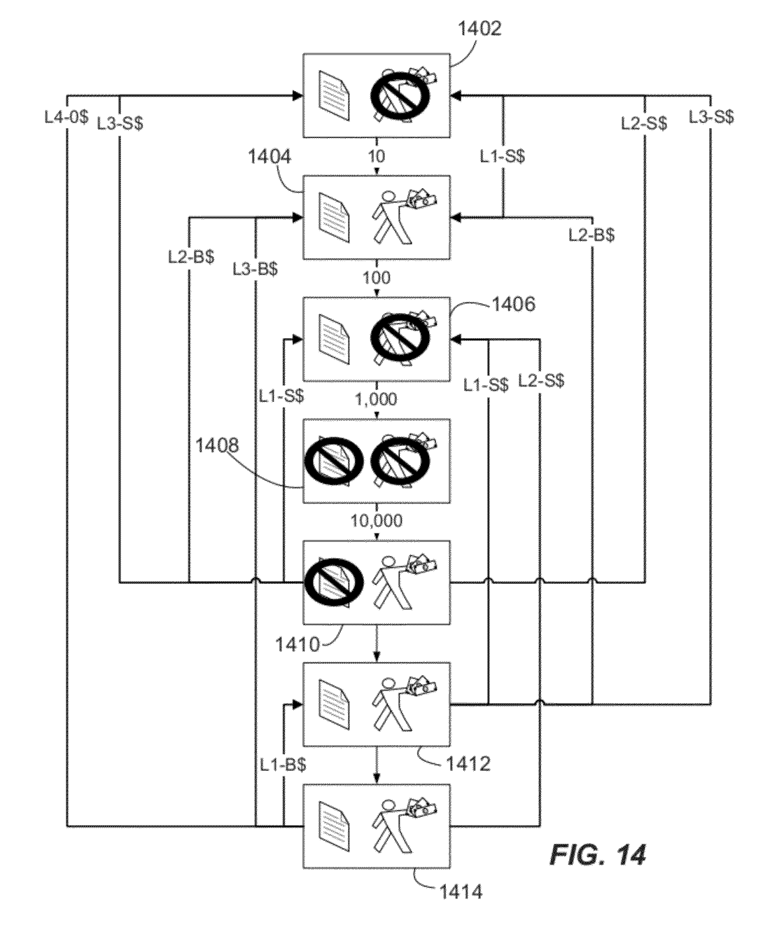

FIG. 14 is an illustration of a more complex series of incentivized transactions. The first sharing participants shown in box 1402 are registered but do not complete purchase transactions in a widget or other portable content distribution device. These first sharing participants do share a web widget with 10 other individuals at a second level of sharing as shown in block 1404 and will be entitled to earn Level1 incentives from purchase transactions completed by these individuals. The individuals at the second sharing level are registered and do complete purchase transactions and subsequently share the web widget with individuals at a third sharing level. In this example the individuals at the third sharing level are registered members but do not complete purchase transactions, as shown in block 1406. The individuals at this third sharing level share the web widget with individuals at a fourth sharing level, as shown in box 1408. The individuals at the fourth sharing level are not registered members and they do not complete purchase transactions. The individuals in this fourth sharing level do share the web widget with individuals at a fifth sharing level (as shown in box 1410), which represents a distribution of the web widget to 10,000 individuals. The individuals at the fifth sharing level do not register in the incentive program but do complete purchase transactions. The individuals at the fifth sharing level in turn share the web widget with an individual at a sixth sharing level who is a registered member in the incentive program and who does complete one or more purchase transactions as shown in block 1412. This individual subsequently shares the web widget with an individual at a seventh sharing level (shown in box 1414) who is a registered member in the incentive program and who does complete one or more purchase transactions using the shared web widget. Users of the widgets at the fourth sharing level and fifth sharing level are not registered in the incentive program and do not qualify to earn incentives although their completed purchase transactions generate incentives for registered members who previously shared the widget the users in this sharing level used. Specifically, since the participants at the fourth sharing level did not complete purchase transactions no incentives were earned from transactions at that level. Since purchase transactions were completed at the fifth sharing level even though the individuals at that level were not registered in the incentive program those purchases still generate incentives for the registered members in the first, second and third sharing levels.

In one embodiment, the amount of incentive earned differs depending on whether the share level participant completed one or more purchase transactions from the widget or portable content distribution device which the participant later shared with other users. In this embodiment, the incentive earned by a registered member who also completes a purchase transaction is higher than the incentive earned by a registered member who only shares the widget or device. The notation in the FIG. 14 for the higher incentive is represented by the capital letter “B” (representing a “buyer incentive”) while the lower incentive is represented by the capital letter “S” (representing a “sharer incentive”). As depicted in FIG. 14, the first sharing level of participants (box 1402) earn a Level1 sharer incentive from purchases completed at the second sharing level (see notation “L1−S$”), a Level2 sharer incentive (“L2−S$”), two Level3 sharer incentives (“L3−S$”) and a Level4 incentive of zero dollars since the incentive program illustrated pays incentives for purchases completed on up to three different sharing levels.

The registered participants in the second level of sharing (see box 1404) qualify to earn buyer incentives from completed purchase transactions arising from distributions of widgets to other users. As shown in FIG. 14, the second level sharing participants (box 1404) earn two Level2 buyer incentives (“L2−B$”) and a Level3 buyer incentive (“L3−B$”). The third sharing level of participants do not complete purchase transactions and therefore only qualify to earn sharer incentives. As shown, the third sharing level of participants (box 1406) earn two Level1 sharer incentives (“L1−S$”) and one Level2 sharer incentive (“L2−S$”). The fourth sharing level of participants (box 1408) are not qualified to earn incentives since they are not registered members and do not generate incentives for any participants in the first three sharing levels since they do not complete any purchase transactions. All incentives generated at subsequent sharing levels will pass over this fourth sharing level and be payable to registered members in the first, second and third sharing levels. The purchasers in the fifth sharing level (box 1410) generate incentives for the first three sharing levels, which incentives include those which are foregone by the individuals in the fourth sharing level. The sixth level of sharing participants (box 1412) qualify to earn incentives and generate incentives from the first, second and third level sharing participants. No incentives are payable to the fourth and fifth sharing levels since the individuals at those levels did not become registered members. Therefore, any incentives generated pass over the fourth and fifth sharing levels and are added to the incentives earned at the first, second and third sharing levels. The individuals in the sixth sharing level do earn incentives from completed purchase transactions at the seventh sharing level since the sixth sharing level participants became registered members in the incentive management service 222. The completed purchase transactions also earn incentives for the first, second and third sharing levels of participants which include incentives which would otherwise have been payable to individuals in the fourth and fifth sharing levels. However, since the incentive program illustrated in this figure only pays incentives for different levels of distribution, no Level4 incentive is payable to the first sharing level of participants.

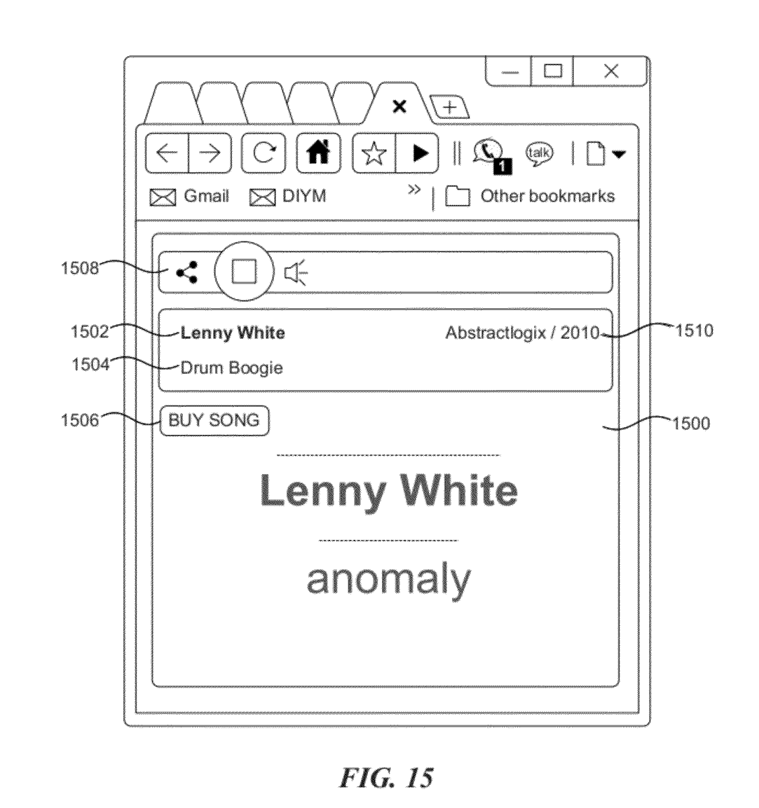

FIG. 15 is an illustration of an activated web widget 1500. In this embodiment, the web widget 1500 includes a field for the content owner's name 1502 (i.e., Lenny White), the name of the musical selection or multimedia content file 1504, a buy button 1506 which will enable the purchase of the multimedia content, which in this embodiment is the musical selection called “Drum Boogie.” The web widget 1500 also includes a field 1510 for the name of the distributor and the year of distribution 2010 (i.e., Abstractlogix/2010) and a field including buttons for limited content previewing and for sharing of the web widget (see triangular shaped symbol with three dots connected by two lines) 1508. The clicking or selection of the triangular shaped symbol initiates a process of generating a new WidgetAliasID to enable the incentivized sharing of the widget if the user sharing the widget is a registered member in the incentive management service 222. If the user is not a registered member, an invitation to join an incentive program will be displayed in the widget and a registration process will then be followed. Also shown in the field 1508 is a play, pause and end-play button. All functionality provided by the web widget 1500 is performed within a browser on a consumer's client device 130, 132, 134.

In the present embodiment, the web widget 1500 is comprised of a content retrieval component, a content preview component and a transaction processing component. Once activated, the content retrieval component will send a request to the widget management service 216 and commence with the retrieval of the multimedia content file and metadata associated with the web widget 1500 from the cloud-based storage resource 124, the database server 110 or other storage resources which are accessible from the application server 106. Once retrieved, a pre-determined portion of the multimedia content file will be automatically executed by the content preview component to enable the consumer to preview the content prior to making a purchase decision. In one embodiment, the pre-determined portion is a thirty second audio clip of a musical selection. In an alternative embodiment, the pre-determined portion is a thirty second audio-visual clip of a multimedia content file. If the consumer elects to purchase the multimedia content file, in this embodiment the “Buy Song” button will be clicked on which will cause the execution of the transaction processing component. The transaction processing component will initiate a commercial transaction pertaining to the multimedia content file, which in the present embodiment will involve the licensing of the multimedia content file to the consumer. In an alternative embodiment, the commercial transaction is the purchase of rights to the multimedia content files. In both embodiments, however, the consummation of the commercial transaction will redirect a consumer to a third party web page shown within the web widget 1500 where the purchase or license transaction will be completed. In an alternative embodiment, the consumer can specifically pre-designate the vendor that operates the multimedia content distribution system 200 as an “approved vendor” with the banks and other financial institutions with which it maintains credit cards, debit cards or other financial accounts (e.g., checking accounts, savings accounts, trading accounts, etc.). In this embodiment, the web widget 1500 will confirm that a purchase or license request has been received and it will execute the purchase or license transaction after receipt of an information signal generated from a single click of a mouse by the consumer on a client device 130, 132, 134 and generate a web page confirming the terms and conditions of the transaction. In an alternative embodiment, the web widget 1500 will automatically execute and complete the purchase or license transaction after receipt of an information signal generated from the pressing of a key on the client device 130, 132, 134 or a gesture on a touchpad provided on the client device 130, 132, 134. In each of these embodiments, once the commercial transaction is completed, all portions of the multimedia content file will be downloaded to the consumer client device 130, 132, 134 for full execution on the client device 130, 132, 134 by the consumer.

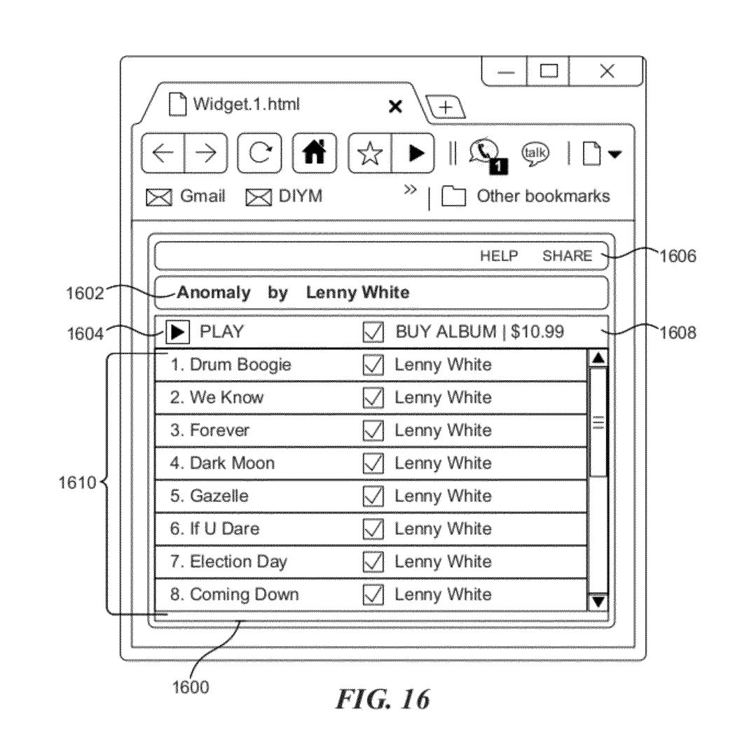

FIG. 16 illustrates an embodiment of a web widget 1600 for a release including multiple selections in an embodiment. All of the multimedia content files included in this embodiment of a web widget 1600 are illustrated and listed in region 1610. In this embodiment the multimedia content files are musical selections. Additional content files can be previewed using the vertical scroll bar shown on the right side of this illustrated web widget 1600. As shown, there are multiple musical selections by an artist named Lenny White included within the web widget 1600. This embodiment of the web widget 1600 also includes a play button 1604, for use in previewing content that has been packaged with the web widget 1600 for promotional purposes. In this embodiment, a consumer can select individual content files (i.e., musical selections) and click on the play button 1604 to preview the selected files, or click on any content file listed in region 1610 to preview only the selected content file. The buy album button 1608 is shown in the same row as the play button 1604 in this embodiment. In addition, the name of the album 1602 (i.e., Anamoly) is shown in the row above the buy button 1604 and buy album 1608 button. As discussed previously, web widgets can be virally distributed and shared with third parties which has the effect of increasing the marketing buzz and name recognition for a content owner. This viral distribution capability is enabled by the share link 1606, as illustrated in this embodiment, and it permits subsequent distribution of the web widget 1600 to other potential consumers in the current users online social networks or other online communities. In one embodiment the selection of this share link initiates the process of generating a new WidgetAliasID for this widget if it is being shared by a registered member in the incentive management service 222. If the user is not a registered member, the selection of this share link will initiate the process of registering the user into an incentive program implemented using the incentive management service 222.

In this alternative embodiment, the web widget 1600 is comprised of a content search component, a content retrieval component, a content preview component and a transaction processing component. Once the widget is activated, the consumer is presented with the listing of multimedia content files included in the compilation associated with the web widget 1600. In this illustrative example, the listing includes the songs provided on the “Anamoly” album by Lenny White. In reviewing the listing of the content files, a consumer can elect to preview one or more of the content files. If the consumer selects one or more of the listed multimedia content files associated with the web widget 1600 for previewing, the content search component will be activated and configured to search for the selected multimedia content files, which files are accessible from the application server 106. After the application server 106 locates the content files, the content retrieval component will send a retrieval request to the widget management service 216 and the widget management service 216 will generate and send a content download request to the application server 106 based on the received retrieval request. After receipt of the content download request from the widget management service 216, the application server 106 will commence the retrieval of the selected multimedia content files and associated metadata. Once retrieved, a pre-determined portion of the selected multimedia content files will be automatically executed by the content preview component to enable the consumer to preview the content files prior to making a purchase decision. In one embodiment, the pre-determined portion is a thirty second audio clip of a musical selection. In an alternative embodiment, the pre-determined portion is a thirty second audio-visual clip of a multimedia content file. If the consumer elects to purchase or license the compilation of multimedia content files, which in this embodiment is an album containing multiple multimedia content files, the consumer will click on the “Buy Album” button 1608 which will result in the activation of the transaction processing component. The transaction processing component will initiate a commercial transaction pertaining to the multimedia content files resulting in the payment of fees and, in this example, the licensing of the compilation of multimedia content files to the consumer. Once the commercial transaction is complete, all portions of the content files in the compilation will be downloaded to the consumer client device 130, 132, 134 for full execution on the client device 130, 132, 134 by the consumer.

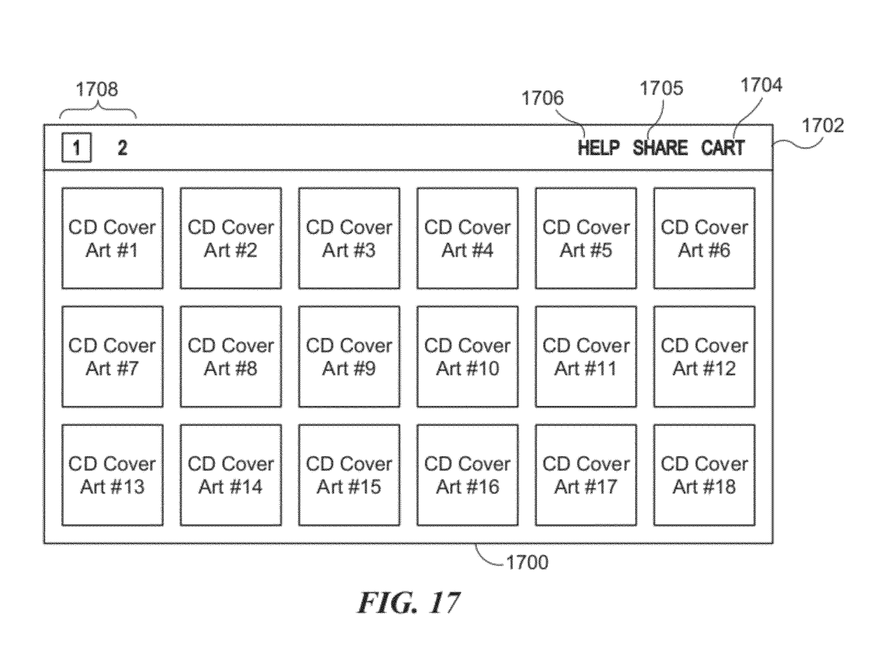

FIG. 17 is an illustration of an active widget for a musical catalog comprised of multiple albums created by a musical artist in an embodiment. The catalog widget 1700 includes a field 1702 with multiple buttons supporting various functions. As shown in this embodiment, the catalog widget 1700 has two pages of content, which pages are accessible by selectable links shown in section 1708. A help button 1706, a cart button 1704 and a share button 1705 are provided to enhance the functionality of the widget. Once a user clicks on or selects the share button 1705, a new WidgetAliasID is generated that is stored in the widget sharing table and tracked for purchase transaction purposes if the user is a registered member with a sharing account in an incentive program maintained using the incentive management service 222. The widget reports each completed purchase transaction to the widget management service 216 arising from registered share events and each registered member who shares this widget will earn incentives from these purchase transactions.

Although specific embodiments have been illustrated and described herein, it will be appreciated by those of ordinary skill in the art that a wide variety of alternate and/or equivalent implementations may be substituted for the specific embodiments shown and described without departing from the scope of the present disclosure. This application is intended to cover any adaptations or variations of the embodiments discussed herein.

What is claimed is:

1. A method for incentivizing social commerce, the method comprising:
generating a user identifier, a widget identifier and an alias identifier, the user identifier generated using an incentive management service to identify a registered member in an incentive program implemented using the incentive management service, the user identifier stored in a database communicatively coupled to an application server, the widget identifier and the alias identifier generated using a widget management service executing on the application server and stored in the database and associated with the user identifier;
building a web widget on the application server, the widget identifier associated with the web widget;
generating a widget alias URL including the alias identifier, the widget alias URL communicatively coupled to the web widget and operative to activate the web widget;
distributing the widget alias URL to at least one network-based application server for execution of the activated web widget by users of a plurality of client devices coupled to the network-based application server, the users comprising a first share level, the activated web widget operative to display one or more multimedia content files available for distribution to each of the plurality of client devices;
storing in the database one or more updated alias identifiers associated with the widget identifier for each subsequent distribution of an updated widget alias URL to each of one or more users of the updated widget alias URL comprising a plurality of additional share levels; and
crediting a sharing account for the registered member with an incentive for each purchase transaction completed by users of the widget alias URL in the first share level and in each of the plurality of additional share levels, the sharing account maintained in the incentive management service.

2. The method of claim 1 wherein the user identifier, the alias identifier and the widget identifier are stored in a widget sharing table in the database, the user identifier stored in a location in the widget sharing table representing a first share level for the registered member, the widget sharing table including at least two additional locations representing at least two additional share levels, the user identifier of the registered member updated to each of the at least two additional share levels as each of the one or more updated alias identifiers are stored in the widget sharing table.

3. The method of claim 1 wherein the incentive management service is further operative to generate a username and a password for the registered member.

4. The method of claim 1 wherein the widget management service is further operative to generate Hypertext Markup Language (HTML) code for embedding into at least one webpage, the HTML code including a hypertext link to activate the web widget.

5. The method of claim 1 wherein the widget management service is further operative to generate JavaScript code for embedding into at least one webpage, the JavaScript code including a link to activate the web widget.

6. The method of claim 1 wherein an amount credited to the sharing account as the incentive depends on whether the registered member purchased content from the activated web widget.

7. The method of claim 1 wherein the database further includes a widget sales table, the widget sales table storing an order identifier for each completed purchase transaction and at least one of the alias identifier and the one or more updated alias identifiers.

8. The method of claim 7 wherein the order identifier is generated using a payment processing service in a multimedia content distribution system, the payment processing service communicatively coupled to the database and the incentive management service.

9. The method of claim 1 wherein the activated web widget is operative to display one or more multimedia content files representing physical goods available for purchase by the registered member and the users in the first share level and in each of the plurality of additional share levels.

10. The method of claim 1 wherein the activated web widget is operative to display one or more multimedia content files representing digital goods available for purchase by the registered member and the users in the first share level and in each of the plurality of additional share levels.

11. The method of claim 1 wherein the activated web widget is operative to display one or more multimedia content files representing digital goods available for licensing by the registered member and the users in the first share level and in each of the plurality of additional share levels.

12. The method of claim 1 wherein the purchase transaction completed by users of the widget alias URL in the first share level and in each of the plurality of additional share levels is a licensing transaction.

13. A system for incentivizing social commerce, the system comprising:
a database server hosting a database, the database including a widget sharing table and a widget sales table; and
an application server communicatively coupled to the database server, the application server having a processor and a memory, the processor programmed to:
generate a user identifier, a widget identifier and an alias identifier, the user identifier generated using an incentive management service to identify a registered member in an incentive program implemented using the incentive management service, the user identifier stored in the database, the widget identifier and the alias identifier generated using a widget management service executing on the application server and stored in the database and associated with the user identifier;
build a web widget on the application server, the widget identifier associated with the web widget;
generate a widget alias URL including the alias identifier, the widget alias URL communicatively coupled to the web widget and operative to activate the web widget;
distribute the widget alias URL to at least one network-based application server for execution of the activated web widget by users of a plurality of client devices coupled to the network-based application server, the users comprising a first share level, the activated web widget operative to display one or more multimedia content files available for distribution to each of the plurality of client devices;
store in the database one or more updated alias identifiers associated with the widget identifier for each subsequent distribution of an updated widget alias URL to each of one or more users of the updated widget alias URL comprising a plurality of additional share levels; and
credit a sharing account for the registered member with an incentive for each purchase transaction completed by users of the widget alias URL in the first share level and in each of the plurality of additional share levels, the sharing account maintained in the incentive management service.

14. The system of claim 13 wherein the user identifier, the alias identifier and the widget identifier are stored in the widget sharing table, the user identifier stored in a location in the widget sharing table representing a first share level for the registered member, the widget sharing table including at least two additional locations representing at least two additional share levels, the user identifier of the registered member updated to each of the at least two additional share levels as each of the one or more updated alias identifiers are stored in the widget sharing table.

15. The system of claim 13 wherein the incentive management service is further operative to generate a username and a password for the registered member.

16. The system of claim 13 wherein the widget management service is further operative to generate Hypertext Markup Language (HTML) code for embedding into at least one webpage, the HTML code including a hypertext link to activate the web widget.

17. The system of claim 13 wherein the widget management service is further operative to generate JavaScript code for embedding into at least one webpage, the JavaScript code including a link to activate the web widget.

18. The system of claim 13 wherein an amount credited to the sharing account as the incentive depends on whether the registered member purchased content from the activated web widget.

19. The system of claim 13 wherein the widget sales table stores an order identifier for each completed purchase transaction and at least one of the alias identifier and the one or more updated alias identifiers.

20. The system of claim 19 wherein the order identifier is generated using a payment processing service in a multimedia content distribution system, the payment processing service communicatively coupled to the database and the incentive management service.

21. The system of claim 13 wherein the activated web widget is operative to display one or more multimedia content files representing physical goods available for purchase by the registered member and the users in the first share level and in each of the plurality of additional share levels.

22. The system of claim 13 wherein the activated web widget is operative to display one or more multimedia content files representing digital goods available for purchase by the registered member and the users in the first share level and in each of the plurality of additional share levels.

23. The system of claim 13 wherein the activated web widget is operative to display one or more multimedia content files representing digital goods available for licensing by the registered member and the users in the first share level and in each of the plurality of additional share levels.

24. The system of claim 13 wherein the purchase transaction completed by users of the widget alias URL in the first share level and in each of the plurality of additional share levels is a licensing transaction.

25. A method of making a web widget for incentivized social commerce, the method comprising:
generating a user identifier, a widget identifier and an alias identifier, the user identifier generated using an incentive management service to identify a registered member in an incentive program implemented using the incentive management service, the widget identifier and the alias identifier generated using a widget management service executing on an application server;
storing the user identifier, the widget identifier and the alias identifier in a widget sharing table, the widget sharing table stored in a database on a database server communicatively coupled to the application server, the user identifier stored in a location in the widget sharing table to identify the registered member as a first share level participant in an incentive program maintained using the incentive management service, the widget sharing table having at least two additional locations to receive at least two additional user identifiers, the location of the user identifier for the registered member as the first share level participant updated to one of the at least two additional locations after receipt of each additional user identifier and each additional alias identifier;
distributing a web widget to at least one network-based application server, the web widget generated from a multimedia content distribution system executing on the application server, the widget identifier and the alias identifier associated with the web widget, the web widget enabled for distribution to a plurality of additional share levels;
storing an order identifier for each purchase transaction completed using the web widget, the order identifier and the alias identifier stored in a widget sales table; and
crediting a sharing account for the registered member with an incentive for each purchase transaction completed by users of the web widget received from the registered member as the first share level participant, the sharing account further credited for each purchase transaction completed by users in each of the plurality of additional share levels, the sharing account maintained in the incentive management service.

26. The method of claim 25 wherein the incentive management service is further operative to generate a username and a password for the registered member.

27. The method of claim 25 wherein the widget management service is further operative to generate Hypertext Markup Language (HTML) code for embedding into at least one webpage, the HTML code including a hypertext link to the web widget.

28. The method of claim 25 wherein the widget management service is further operative to generate JavaScript code for embedding into at least one webpage, the JavaScript code including a link to the web widget.

29. The method of claim 25 wherein an amount credited to the sharing account as the incentive depends on whether the registered member purchased content from the web widget.

30. The method of claim 25 wherein the order identifier is generated using a payment processing service in the multimedia content distribution system, the payment processing service communicatively coupled to the database and the incentive management service.

31. The method of claim 25 wherein the web widget is operative to display one or more multimedia content files representing physical goods available for purchase by the registered member, the users who received the web widget from the registered member as the first share level participant, and the users in each of the plurality of additional share levels.

32. The method of claim 25 wherein the web widget is operative to display one or more multimedia content files representing digital goods available for purchase by the registered member, the users who received the web widget from the registered member as the first share level participant, and the users in each of the plurality of additional share levels.

33. The method of claim 25 wherein the web widget is operative to display one or more multimedia content files representing digital goods available for licensing by the registered member, the users who received the web widget from the registered member as the first share level participant, and the users in each of the plurality of additional share levels.

34. The method of claim 25 wherein the purchase transaction completed by users of the web widget is a licensing transaction.

35. An apparatus for maintaining sharing relationships in incentivized social commerce, the apparatus comprising:
an application server having a processor and an interface for communicating over a computer network, the application server communicatively coupled to a database server; and
a multimedia content distribution system executed on the processor and operative to build one or more web widgets and to distribute the one or more web widgets over the computer network, the multimedia content distribution system including a widget management service and an incentive management service, the incentive management service including a registration component, an event management component and an incentive tracking component,
the widget management service operative to generate a widget identifier for each of the one or more web widgets, an alias identifier for each of the one or more web widgets distributed over the computer network and at least one widget alias URL communicatively coupled to each of the one or more web widgets and operative to activate the one or more web widgets after distribution of the one or more web widgets over the computer network to one or more network-based application servers,
the registration component operative to generate a user identifier, a user profile, a username and a password, the registration component further operative to store the user identifier in a database hosted on the database server,
the event management component operative to maintain a widget sharing table and a widget sales table, the widget sharing table and the widget sales table stored in the database, the widget sharing table including a plurality for records for storing at least one alias identifier, the widget identifier and at least one user identifier, each of the at least one user identifier associated with a share level for a registered member, the widget sales table including a record for storing the alias identifier and an order identifier associated with each purchase transaction completed with the one or more web widgets, the event management component further operative to update a share level for the registered member upon addition of an updated alias identifier to the widget sharing table, the updated alias identifier generated when each of the one or more web widgets is distributed over the computer network to the one or more network-based application servers,
the incentive tracking component operative to determine one or more earned incentives for the registered member for each purchase transaction completed on each of a plurality of share levels, each of the plurality of share levels comprising recipients of the widget alias URL.

36. The apparatus of claim 35 wherein the widget management service is operative to generate Hypertext Markup Language (HTML) code for embedding into at least one webpage, the HTML code including a hypertext link to activate the one or more web widgets.

37. The apparatus of claim 35 wherein the widget management service is operative to generate JavaScript code for embedding into at least one webpage, the JavaScript code including a link to activate the web widget.

38. The apparatus of claim 35 wherein the amount of the one or more earned incentives depends on whether the registered member purchased content from the activated web widget.

39. The apparatus of claim 35 wherein the order identifier is generated using a payment processing service in the multimedia content distribution system, the payment processing service communicatively coupled to the database and the incentive management service.

40. The apparatus of claim 35 wherein each of the one or more web widgets is operative to display one or more multimedia content files representing physical goods available for purchase by the registered member and the users in the first share level and in each of the plurality of additional share levels.

41. The apparatus of claim 35 wherein each of the one or more web widgets is operative to display one or more multimedia content files representing digital goods available for purchase by the registered member and the users in the first share level and in each of the plurality of additional share levels.

42. The apparatus of claim 35 wherein each of the one or more web widgets is operative to display one or more multimedia content files representing digital goods available for licensing by the registered member and the users in the first share level and in each of the plurality of additional share levels.

43. The apparatus of claim 35 wherein the purchase transaction completed by recipients of the widget alias URL is a licensing transaction.

44. A computer-readable medium having instructions stored thereon for performing a method comprising:
generating a user identifier, a widget identifier and an alias identifier, the user identifier generated using an incentive management service to identify a registered member in an incentive program implemented using the incentive management service, the user identifier stored in a database communicatively coupled to an application server, the widget identifier and the alias identifier generated using a widget management service executing on the application server and stored in the database and associated with the user identifier;
building a web widget on the application server, the widget identifier associated with the web widget;
generating a widget alias URL including the alias identifier, the widget alias URL communicatively coupled to the web widget and operative to activate the web widget;
distributing the widget alias URL to at least one network-based application server for execution of the activated web widget by users of a plurality of client devices coupled to the network-based application server, the users comprising a first share level, the activated web widget operative to display one or more multimedia content files available for distribution to each of the plurality of client devices;
storing in the database one or more updated alias identifiers associated with the widget identifier for each subsequent distribution of an updated widget alias URL to each of one or more users of the updated widget alias URL comprising a plurality of additional share levels; and
crediting a sharing account for the registered member with an incentive for each purchase transaction completed by users of the widget alias URL in the first share level and in each of the plurality of additional share levels, the sharing account maintained in the incentive management service.

45. The computer-readable medium of claim 44 wherein the user identifier, the alias identifier and the widget identifier are stored in a widget sharing table in the database, the user identifier stored in a location in the widget sharing table representing a first share level for the registered member, the widget sharing table including at least two additional locations representing at least two additional share levels, the user identifier of the registered member updated to each of the at least two additional share levels as each of the one or more updated alias identifiers are stored in the widget sharing table.

46. The method of claim 44 wherein the incentive management service is further operative to generate a username and a password for the registered member.

47. The method of claim 44 wherein the widget management service is further operative to generate Hypertext Markup Language (HTML) code for embedding into at least one webpage, the HTML code including a hypertext link to activate the web widget.

48. The method of claim 44 wherein the widget management service is further operative to generate JavaScript code for embedding into at least one webpage, the JavaScript code including a link to activate the web widget.

49. The method of claim 44 wherein an amount credited to the sharing account as the incentive depends on whether the registered member purchased content from the activated web widget.

50. The method of claim 44 wherein the database further includes a widget sales table, the widget sales table storing an order identifier for each completed purchase transaction and at least one of the alias identifier and the one or more updated alias identifiers.

51. The method of claim 50 wherein the order identifier is generated using a payment processing service in a multimedia content distribution system, the payment processing service communicatively coupled to the database and the incentive management service.

52. The method of claim 44 wherein the activated web widget is operative to display one or more multimedia content files representing physical goods available for purchase by the registered member and the users in the first share level and in each of the plurality of additional share levels.

53. The method of claim 44 wherein the activated web widget is operative to display one or more multimedia content files representing digital goods available for purchase by the registered member and the users in the first share level and in each of the plurality of additional share levels.

54. The method of claim 44 wherein the activated web widget is operative to display one or more multimedia content files representing digital goods available for licensing by the registered member and the users in the first share level and in each of the plurality of additional share levels.

55. The method of claim 44 wherein the purchase transaction completed by users of the widget alias URL in the first share level and in each of the plurality of additional share levels is a licensing transaction.
